(19) United States
(12) Patent Application Publication
(10) Pub. No.: US 2007/0011679 A1
(43) Pub. Date: Jan. 11, 2007

(54) Peripheral apparatus control system, information processing apparatus, method for controlling information processing apparatus, and program

(75) Inventor: Koichi Abe, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/435,519

(22) Filed: May 17, 2006

(30) Foreign Application Priority Data
May 27, 2005 (JP) 2005-155536

(51) Int. Cl. G06F 9/46

(52) U.S. Cl. 718/100

(57) ABSTRACT

When a communication link is disconnected during a printing operation of a print job due to deteriorated radio wave conditions, a printer can prevent and/or reduce incorrect print or other malfunction occurring in response to a print control command included in the print job. Furthermore, in a state monitor function of a peripheral apparatus, when establishment or disconnection of the communication link is unclear due to deteriorated radio wave conditions, the monitor does not fall into an uncontrollable state. A port monitor (PM), controlling a communication interface, confirms a state of the communication interface. A language monitor (LM), controlling a peripheral apparatus, confirms a state of the communication interface. Communications with the peripheral apparatus can be performed based on a state confirmation result of the LM. Furthermore, a transmission buffer is cleared in response to disconnection of the communications.

### BACKGROUND OF THE INVENTION

1. Field of the Invention

The present invention relates to a peripheral apparatus control system including an information processing apparatus and a peripheral apparatus (e.g., a printer). Furthermore, the present invention relates to an information processing apparatus, a method for controlling the information processing apparatus, and a related program.

2. Description of the Related Art

Wired interfaces, such as parallel, serial, Universal Serial Bus (USB), IEEE1394, and Ethernet™ interfaces, can be used to connect information processing apparatuses and peripheral apparatuses. The wired interfaces can assure stable communications performed between the information processing apparatuses and the peripheral apparatuses. In other words, deterioration or disconnection in the communications does not occur unless a cable of the wired interface is damaged or disconnected.

In addition to conventional wired interfaces, there are new type wireless interfaces, such as Bluetooth, wireless LAN (e.g., IEEE802.11a/b/g), and Wireless USB. For example, a personal computer (hereinafter, referred to as a PC) or other information processing apparatus can be connected to a printer or other peripheral apparatus via a Bluetooth interface (i.e., one of wireless interfaces). Communications performed via such wireless interfaces are unstable compared with the communications using the wired interfaces when the distance is insufficient, obstacles are present, or radio wave conditions are undesirable. As a result, wireless communications may be temporarily deteriorated or disconnected depending on radio wave conditions.

According to a wireless system, a communication link for the Bluetooth communications (Asynchronous Connection-Less (ACL) and Hardcopy Cable Replacement Profile (HCRP)) is established when a print job is started. During the processing of a print job, a print control command representing print image data is transmitted to the printer. After accomplishing the print job, the communication link for the Bluetooth communications (ACL and HCRP) is disconnected. In such a wireless system, the communication link may be disconnected due to deteriorated radio wave conditions. If such a disconnection occurs during transmission of the print control command, the print job will end in failure when the transmission processing includes no recovery processing for reestablishing the communication link.

In general, printers include various operation modes, including a neutral mode corresponding to an ordinary standby state, a print control mode corresponding to a print processing state, and a maintenance mode corresponding to a maintenance processing state. The printer can shift its operation among these modes in response to a control command sent from the PC. In each mode, the printer receives and interprets a control command transmitted from the PC and controls its operation according to the received command.

For example, there is a printer that can initialize its internal device (hardware and firmware) controlling the Bluetooth communications to prevent occurrence of any malfunction if the communication link is disconnected due to deteriorated radio wave conditions during a printing operation in the print control mode. This kind of printer can initialize the internal processing to return to a neutral mode.

For instance, an application installed on the information processing apparatus can include a function for confirming a state of a peripheral apparatus (e.g., a printer) and displaying the state. In the following description, the application including such a monitoring function is referred to as a status monitor. The status monitor can receive a control command representing a momentary state of the peripheral apparatus (hereinafter, referred to as a status control command) by performing polling at predetermined time intervals, and can update a state display according to the status control command. For example, substantially real-time state display for a peripheral apparatus can be realized by performing the polling at intervals of 5 seconds.

As described above, unlike the wired interfaces, the wireless interfaces are inherently subjected to undesirable deterioration or disconnection of the communications. Print jobs tend to end in failure due to deterioration or disconnection of the communications. As a method for solving such problems, if the communication link is disconnected during a printing operation using a wireless interface, the information processing apparatus can execute recovery processing for re-establishing the communication link to continue a pending print job. In this case, the printer needs to initialize its wireless control feature (hardware or firmware) in response to disconnection of the communication link during a printing operation in the print control mode, so as to continue the print control mode without shifting to the neutral mode.

However, if the information processing apparatus executing such a print control is combined with a conventional printer that cannot comply with such a print control, the printer will initialize its internal processing in response to a disconnection of the communication link during a printing operation and will return its operation to the neutral mode. Accordingly, the printer cannot correctly interpret a print control command received in the succeeding processing of a print job. For example, the printer will cause incorrect print or other malfunction.

Furthermore, the communication interface can be USB or other wired interface, or can be Bluetooth or other wireless interface. In the case of the wired interfaces, a status control command can be received by performing polling at intervals of, for example, 5 seconds, so that the state display for a peripheral apparatus can be stably updated.

However, in the case of the wireless interfaces, due to deteriorated radio wave conditions, it may be unclear whether the communication link is established or disconnected. In such a case, if reception of a status control command is tried by performing polling, the hardware or firmware controlling a wireless interface will repeat retrial of reception. The status monitor will be brought into an uncontrollable state.

Therefore, it would be desirable to provide a status monitor that can continue a stable state. Furthermore, it would be advantageous to provide a technique capable of preventing and/or reducing any malfunction of a peripheral apparatus caused by a change in a communication state of a communication interface. Moreover, it would be beneficial to provide a technique capable of preventing and/or reducing any uncontrollable state caused by a change in the communication state of the communication interface.

### SUMMARY OF THE INVENTION

The present invention is directed to a status monitor that can continue a stable state. Furthermore, the present invention is directed to a technique capable of preventing and/or reducing any malfunction of a peripheral apparatus caused by a change in a communication state of a communication interface. Additionally, the present invention is directed to a technique capable of preventing and/or reducing any uncontrollable state caused by a change in the communication state of the communication interface.

At least one exemplary embodiment is directed to a peripheral apparatus control system which includes an information processing apparatus including, a communication interface control unit which includes a first confirmation unit; and a peripheral apparatus control unit which includes a second confirmation unit; a peripheral apparatus; and a communication interface configured to provide a communication link between the information processing apparatus and the peripheral apparatus, wherein the first and second confirmation units are configured to confirm a communication state of the communication interface, wherein the communication interface control unit is configured to control the communication interface, wherein the peripheral apparatus control unit is configured to control the peripheral apparatus, and wherein the peripheral apparatus control unit is configured to communicate with the peripheral apparatus based on a confirmation result of the communication state of the communication interface confirmed by the second confirmation unit. Furthermore, according to another aspect of the present embodiment, the communication interface is a wireless communication interface.

At least one exemplary embodiment is directed to an information processing apparatus configured to communicate with a peripheral apparatus via a communication interface, the information processing apparatus including a communication interface control unit which includes a first confirmation unit, the communication interface control configured to control the communication interface; and a peripheral apparatus control unit which includes a second confirmation unit, the peripheral apparatus control unit configured to control the peripheral apparatus; wherein the first and second confirmation units are configured to confirm a communication state of the communication interface, wherein the peripheral apparatus control unit is configured to communicate with the peripheral apparatus based on a confirmation result of the communication state of the communication interface confirmed by the second confirmation unit. And according to an aspect of the embodiment, the communication interface is a wireless communication interface.

At least one exemplary embodiment is directed to a control method for an information processing apparatus configured to communicate with a peripheral apparatus via a communication interface, including a communication interface control step of controlling the communication interface; and a peripheral apparatus control step of controlling the peripheral apparatus, wherein the communication interface control step includes execution of a first confirmation step of confirming a communication state of the communication interface; and the peripheral apparatus control step includes execution of a second confirmation step of confirming a communication state of the communication interface, wherein the peripheral apparatus control step includes communicating with the peripheral apparatus based on a confirmation result of the communication state of the communication interface confirmed in the second confirmation step.

At least one exemplary embodiment is directed to a program executable by an information processing apparatus configured to communicate with a peripheral apparatus via a communication interface, including a communication interface control module for controlling the communication interface; and a peripheral apparatus control module for controlling the peripheral apparatus, wherein the communication interface control module executes a first confirmation step of confirming a communication state of the communication interface, and the peripheral apparatus control module executes a second confirmation step of confirming a communication state of the communication interface, wherein the peripheral apparatus control module executes processing for communicating with the peripheral apparatus based on a confirmation result of the communication state of the communication interface confirmed in the second confirmation step.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous embodiments of the invention and, together with the description, serve to explain the principles of the invention.

FIG. 1 is a block diagram showing an exemplary arrangement of a peripheral apparatus control system including an information processing apparatus and a peripheral apparatus, according to an aspect of the present invention.

FIG. 2 is a block diagram showing an exemplary hardware arrangement of a personal computer (PC) according to an aspect of the present invention.

FIG. 3 is a block diagram showing an exemplary hardware arrangement of a printer, according to an aspect of the present invention.

FIG. 4 is a block diagram showing an exemplary arrangement of a printer driver in the PC, according to an aspect of the present invention.

FIG. 5 is a function flow showing an exemplary printing operation performed via a USB interface, according to an aspect of the present invention.

FIG. 6 is a function flow showing a conventional printing operation performed via a Bluetooth interface.

FIG. 7 is a function flow showing a printing operation performed via the Bluetooth interface, according to an aspect of the present invention.

FIG. 8 is a function flow showing an exemplary printing operation performed via the Bluetooth interface, according to an aspect of the present invention.

FIG. 9 is a flowchart showing exemplary processing of an LM_StartDocPort( ) function in a language monitor (LM) described with reference to FIGS. 5 and 6, according to an aspect of the present invention.

FIG. 10 is a flowchart showing exemplary processing of an LM_WritePort( ) function in the LM described with reference to FIGS. 5 and 6 and an LM_ReadPort( ) function in the LM described with reference to FIG. 24, according to an aspect of the present invention.

FIG. 11 is a flowchart showing exemplary processing of an LM_EndDocPort( ) function in the LM described with reference to FIGS. 5 and 6, according to an aspect of the present invention.

FIG. 12 is a flowchart showing exemplary processing of a PM_StartDocPort( ) function in a port monitor (PM) described with reference to FIGS. 5 and 6, according to an aspect of the present invention.

FIG. 13 is a flowchart showing exemplary processing of a PM_WritePort( ) function in the PM described with reference to FIGS. 5 and 6 and a PM_ReadPort( ) function in the PM described with reference to FIG. 24, according to an aspect of the present invention.

FIG. 14 is a flowchart showing exemplary processing of a PM_EndDocPort( ) function in the PM described with reference to FIGS. 5 and 6, according to an aspect of the present invention.

FIG. 15 is a flowchart showing exemplary processing of a USB_Send( ) function in a USB HW (Stack) and a BT_Send1( ) function in a Bluetooth HW (Stack) described with reference to FIGS. 5 and 6, as well as a USB_Receive( ) function in the USB HW (Stack) and a BT_Receive1( ) function in the Bluetooth HW (Stack) described with reference to FIGS. 26 and 24, according to an aspect of the present invention.

FIG. 16 is a flowchart showing exemplary processing of the LM_StartDocPort( ) function in the LM described with reference to FIG. 7, according to an aspect of the present invention.

FIG. 17 is a flowchart showing exemplary processing of the LM_WritePort( ) function in the LM described with reference to FIG. 7 and the LM_ReadPort( ) function in the LM described with reference to FIG. 25, according to an aspect of the present invention.

FIG. 18 is a flowchart showing exemplary processing of the LM_EndDocPort( ) function in the LM described with reference to FIG. 8, according to an aspect of the present invention.

FIG. 19 is a flowchart showing exemplary processing of the PM_WritePort( ) function in the PM described with reference to FIG. 7 and the PM_ReadPort( ) function in the PM described with reference to FIG. 25, according to an aspect of the present invention.

FIG. 20 is a flowchart showing an exemplary processing of a BT_CheckConnection( ) function in the Bluetooth HW (Stack) described with reference to FIGS. 7 and 25, according to an aspect of the present invention.

FIG. 21 is a flowchart showing exemplary processing of a BT_Send2( ) function in the Bluetooth HW (Stack) described with reference to FIG. 7 and a BT_Receive2( ) function in the Bluetooth HW (Stack) described with reference to FIG. 25, according to an aspect of the present invention.

FIG. 22 is a flowchart showing exemplary processing of BT_Connect( ) function in the Bluetooth HW (Stack) described with reference to FIGS. 6 and 7, according to an aspect of the present invention.

FIG. 23 is a flowchart showing exemplary processing of a BT_Disconnect( ) function in the Bluetooth HW (Stack) described with reference to FIGS. 6 and 8, according to an aspect of the present invention.

FIG. 24 is a function flow showing a conventional printing operation performed via the Bluetooth interface in a condition that a status monitor of FIG. 32 is activated.

FIG. 25 is a function flow showing an exemplary printing operation performed via the Bluetooth interface in a condition that the status monitor of FIG. 32 is activated, according to an aspect of the present invention.

FIG. 26 is a function flow showing an exemplary printing operation performed via a USB interface in a condition that the status monitor of FIG. 32 is activated, according to an aspect of the present invention.

FIG. 27 is a view showing the definition of functions exported from the LM, according to an aspect of the present invention.

FIG. 28 is a view showing the definition of functions exported from the PM, according to an aspect of the present invention.

FIG. 29 is a view showing the definition of exemplary functions and related constants used in the functions exported from the PM, according to an aspect of the present invention.

FIG. 30 is a view showing the definition of functions exported from the USB HW (Stack), according to an aspect of the present invention.

FIG. 31 is a view showing the definition of functions exported from the Bluetooth HW (Stack), according to an aspect of the present invention.

FIG. 32 is a view showing an example of the status monitor that monitors the state of a printer, according to an aspect of the present invention.

FIG. 33 is an exemplary memory map of a storage medium that stores various data processing programs readable by the peripheral apparatus control system, according to an aspect of the present invention.

### DETAILED DESCRIPTION OF THE EMBODIMENTS

Numerous exemplary embodiments will now be herein described in detail below with reference to the drawings. It is noted that the following description of the numerous exemplary embodiments of the present invention are merely illustrative in nature and is in no way intended to limit the invention, its application, or uses.

Further, it is noted that throughout the specification, similar reference numerals and letters refer to similar items in the following figures, and thus once an item is defined in one figure, it may not be discussed for following figures in an effort to reduce repetitive discussion.

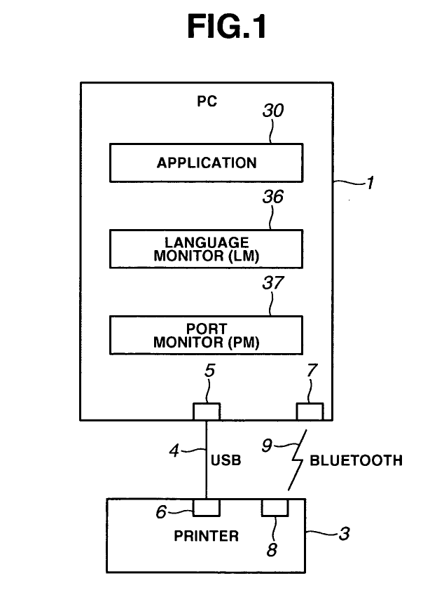

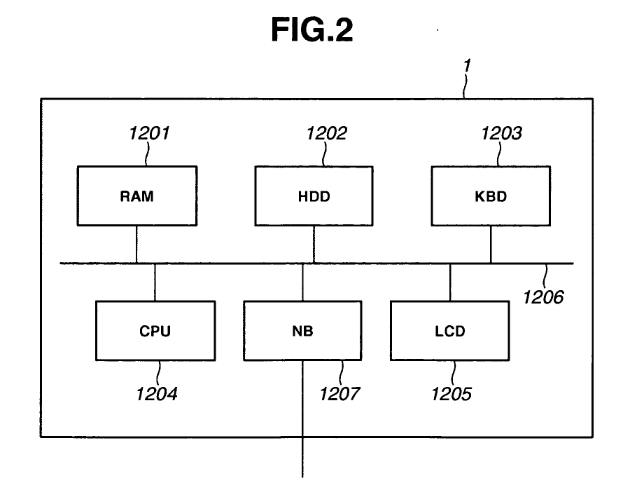

FIG. 1 is a block diagram showing an exemplary arrangement of a peripheral apparatus control system including an information processing apparatus and a peripheral apparatus. In FIG. 1, an information processing apparatus 1 may be, for example, a general personal computer (hereinafter, referred to as a PC). The PC 1 has a hardware arrangement shown in FIG. 2 and can operate various processing under an operating system (OS), such as Windows™ XP provided by Microsoft Corporation.

The information processing apparatus 1 includes a USB port 5 that has a hardware arrangement capable of controlling Universal Serial Bus (USB) devices and a Bluetooth port 7 that has a hardware arrangement capable of controlling Bluetooth communications. A printer 3 is a color inkjet printer capable of functioning as a peripheral apparatus in the present exemplary embodiment. For sake of explanation, the printer 3 has a model name “kmmn” manufactured by XYZ Corporation.

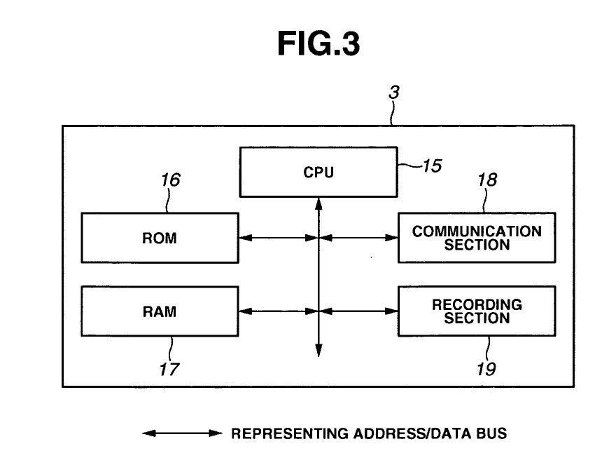

The peripheral apparatus of the present exemplary embodiment can be selected from an image forming apparatus (e.g., a printer, a copying machine, a facsimile, or a multifunction peripheral), a scanner, and a digital camera. The printer 3 has a hardware arrangement shown in FIG. 3 which will be discussed later in greater detail. The printer 3 has a USB port 6 that has a hardware arrangement capable of controlling USB devices, and a Bluetooth port 8 that has a hardware arrangement capable of controlling Bluetooth communications. The printer 3 is connected to the PC 1 via a USB interface 4 or a Bluetooth interface 9, so that bidirectional communications can be realized between the printer 3 and the PC 1.

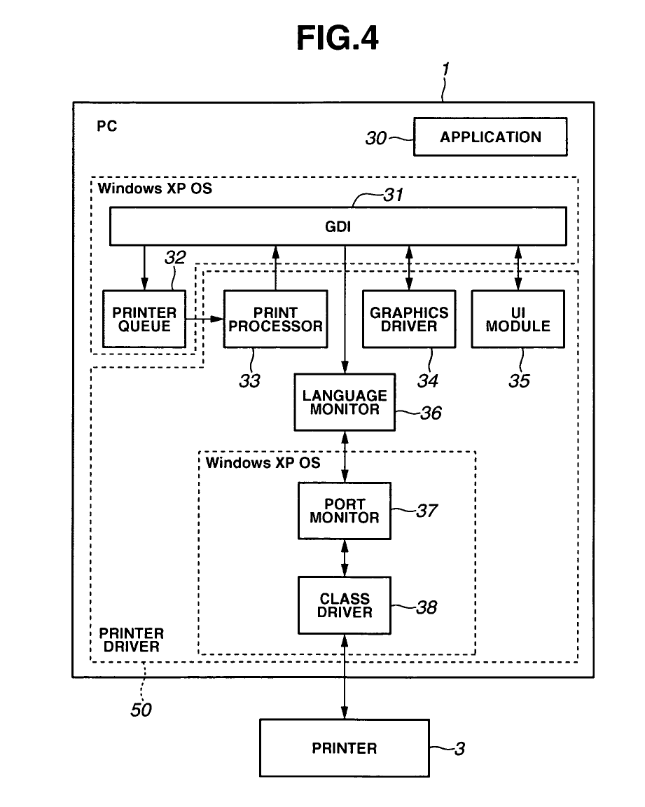

The PC 1 includes a language monitor (hereinafter, sometimes referred to as an LM) 36 and a port monitor (hereinafter, sometimes referred to as a PM) 37 which are later described with reference to FIG. 4. Each of the language monitor 36 and the port monitor 37 is constituted by a dynamic link library for the Windows (registered trademark). The PC 1 includes an application 30 constituted as a file (*.EXE) formatted so as to be executable in the Windows (registered trademark). One example of the application 30 is the memo pad/Notepad (Notepad.exe), i.e., a text editor packaged in the Windows (registered trademark) XP OS, or other application that can execute a printing operation. When a print is instructed on the application 30 (e.g., the memo pad), a printing operation can be started by selecting a driver of the printer 3 connected to the PC 1. With this operation, the printer 3 can print the contents of a text document.

FIG. 2 is a block diagram showing an exemplary hardware arrangement of the PC 1. The PC 1 includes a random access memory section (RAM 1201), a hard disk drive section (HDD 1202) functioning as a storage section, a keyboard section (KBD 1203) functioning as an input section, a control section (CPU 1204), a display unit (LCD 1205) functioning as a display section, a network board (NB 1207) functioning as a communication control section, and a bus 1206 connecting the constituent components of the PC 1.

The NB 1207 includes the USB port 5 for the USB interface 4 and the Bluetooth port 7 for the Bluetooth interface 9 which can control USB and Bluetooth communications. The storage section can be a portable CD-ROM or a built-in ROM. Respective modules (i.e., application 30, LM 36, and PM 37) of the PC 1 shown in FIG. 1 are stored in the HDD 1202 and can be loaded into the RAM 1201 so that the CPU 1204 can execute each module. The CPU 1204 can realize the functions of respective modules shown in FIG. 1.

FIG. 3 is a block diagram showing an exemplary hardware arrangement of the printer 3. The printer 3 includes a CPU 15 (e.g., a microprocessor) that can function as a central processing unit controlling a RAM 17, a communication section 18, and a recording section 19 according to a program stored in the ROM 16. The ROM 16 stores a program controlling the printer 3 to execute recording output (i.e., print) processing according to instructions of a printer driver 50 (later described in FIG. 4). The RAM 17 temporarily stores print data transmitted from the PC 1 before the print data is printed in the recording section 19. The communication section 18 includes the USB port 6 for the USB interface 4 and the Bluetooth port 8 for the Bluetooth interface 9 which can control USB and Bluetooth communications. The recording section 19 can execute an inkjet printing operation.

When a user instructs a printing operation on an application, the HDD 1202 of the PC 1 temporarily stores, as an EMF-format spool file, display contents (image data) of an application currently opened on the PC 1. The printer driver 50 converts the EMF-format spool file into print data including printer control commands, and then transmits the print data via the USB interface 4 or the Bluetooth interface 9 to the printer 3. The printer 3 receives the print data. The recording section 19 converts the received print data into print pulses so that the print data can be printed on a recording paper. The printer 3 can perform print controls according to print control commands produced by the printer driver 50 and transmitted from the PC 1. The print control commands include print data.

Upon activation, the printer 3 starts its operation in a neutral mode representing an ordinary standby state. If the printer 3 receives a print start command, the printer 3 shifts its operation from the neutral mode to a print control mode. In the print control mode, the printer 3 processes the data transmitted from the PC 1 as print control commands. The printer 3 stops a printing operation in response to a print termination command.

If the printer 3, operating in the neutral mode, receives a maintenance command instructing execution of maintenance processing, the printer 3 shifts its operation into a maintenance mode. Then, the printer 3 executes appropriate maintenance processing according to the maintenance command. When the maintenance processing is terminated, the printer 3 returns its operation to the neutral mode. The maintenance processing is, for example, cleaning of a recording head.

In the condition that a communication link (ACL and HCRP) for the Bluetooth communications is established, the communication section 18 shifts its operation into the neutral mode to prevent and/or reducing any malfunction if the communication link is disconnected, for example, due to deteriorated radio wave conditions.

Accordingly, the printer 3 shifts its operation from the print control mode to the neutral mode, if the communication link is disconnected during a printing operation due to deteriorated radio wave conditions for the wireless communications. The communication link can be re-established when the radio wave conditions for the wireless communications become better. If a print control command is transmitted from the PC 1 in this condition, the printer 3 cannot interpret the print control command because the printer 3 is operating in the neutral mode. Therefore, incorrect print or other malfunction will occur depending on the contents of data included in the transmitted print control command.

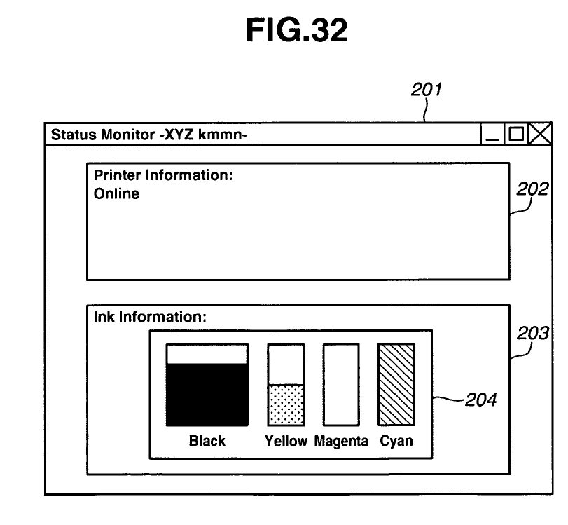

FIG. 4 is a block diagram showing an exemplary arrangement of the printer driver of the PC 1. The printer driver 50 includes plural modules 33 to 38 as drivers installed on the PC 1. The application 30 is the application software that can instruct a printing operation. For example, the application 30 corresponds to the memo pad/Notepad (Notepad.exe), i.e., a text editor packaged in the Windows (registered trademark) XP OS, or a status monitor described in FIG. 32. A graphics device interface (GDI) 31 is part of the Windows (registered trademark) XP OS. A printer queue 32, which queues a print job, is part of the Spooler of the Windows (registered trademark) XP OS.

The printer driver 50 includes a print processor 33, a graphics driver 34, a UI module 35, the language monitor (LM) 36 described in FIG. 1, the port monitor (PM) 37 described in FIG. 1, and a class driver 38. The print processor 33 can change the print layout and execute special processing applied to a print image. The graphics driver 34 acts as a core section of the printer driver 50 that performs the image processing. The graphics driver 34 can execute image processing for a printing operation based on a drawing command transmitted from the GDI 31, and can create a print control command. The UI module 35 can provide and control a user interface of the printer driver 50. The language monitor (LM) 36 can control transmission/reception of data, as a communication interface (I/F) of the data.

The PM 37 can receive data transmitted from the LM 36 and transmit the received data to an appropriate port, and also can receive data transmitted from the printer 3 via the class driver 38. The class driver 38 is a low-level module closest to the port. The class driver 38 of the present exemplary embodiment corresponds to a driver controlling a stack of Printer Class of the USB or a driver controlling a stack of Hardcopy Cable Replacement Profile (HCRP) of the Bluetooth. The class driver 38 can control the port (i.e., the USB port 5 or the Bluetooth port 7).

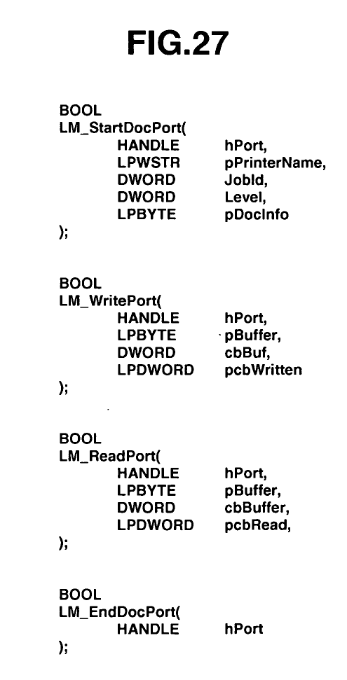

FIG. 27 is a view showing the definition of functions exported from the LM 36. Hereinafter, only the functions relating to the present exemplary embodiment will be described. The Spooler calls an LM_StartDocPort( ) function when a print job is started. The Spooler calls an LM_WritePort( ) function when command data, such as a print start command, a print control command, and a print termination command, is transmitted to the printer 3. An argument pBuffer of this function sets the data to be transmitted to the printer 3. An argument cbBuf sets the size of the data (units: byte). The LPDWORD is a pointer indicating an unsigned double word (unsigned long, 32 bits). An argument pcbWritten sets the size of data actually transmitted to the printer 3 when the function is returned. Furthermore, the pcbWritten is a pointer variable of the unsigned double word (i.e., a variable representing an address of *pcbWritten). The data referred to by the *pcbWritten represents a memory value in an address of the pcbWritten.

The Spooler calls an LM_ReadPort( ) function when the status monitor obtains a status control command from the printer 3. An argument pBuffer of this function sets the data transmitted from the printer 3 that is actually obtained by the PC 1 when the function is returned. An argument pcbRead sets the size of the data when the function is returned.

The pcbRead is a pointer variable of the unsigned double word (i.e., a variable representing an address of *pcbRead). The data referred to by the *pcbRead represents a memory value in an address of the pcbRead. The Spooler calls an LM_EndDocPort( ) function when the print job is terminated.

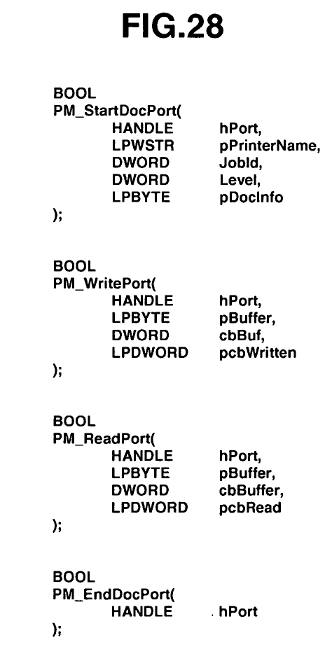

FIG. 28 is a view showing the definition of functions exported from the PM 37. Only the functions relating to the present exemplary embodiment will be described below. The LM 36 calls a PM_StartDocPort( ) function when a print job is started. The LM 36 calls a PM_WritePort( ) function when command data, such as a print start command, a print control command, and a print termination command, is transmitted to the printer 3. An argument pBuffer of this function sets the data to be transmitted to the printer 3. An argument cbBuf sets the size of the data (units: byte). The LPDWORD is a pointer indicating an unsigned double word (unsigned long, 32 bits). An argument pcbWritten sets the size of data actually transmitted to the printer 3 when the function is returned. The pcbWritten is a pointer variable of the unsigned double word (i.e., a variable representing an address of *pcbWritten). The data referred to by the *pcbWritten represents a memory value in an address of the pcbWritten.

The LM 36 calls a PM_ReadPort( ) function when the status monitor obtains a status control command from the printer 3. An argument pBuffer of this function sets the data transmitted from the printer 3 that is actually obtained by the PC 1 when the function is returned. An argument pcbRead sets the size of the data when the function is returned. The pcbRead is a pointer variable of the unsigned double word (i.e., a variable representing an address of *pcbRead). The data referred to by the *pcbRead represents a memory value in an address of the pcbRead. The LM 36 calls a PM_EndDocPort( ) function when the print job is terminated.

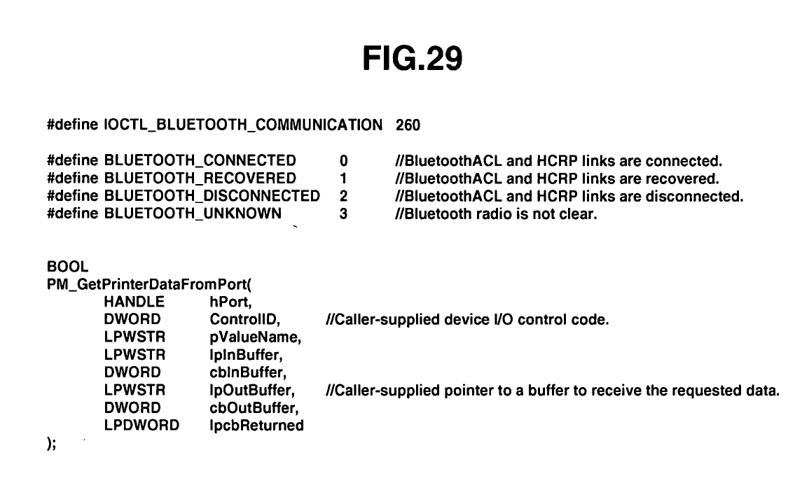

FIG. 29 is a view showing the definition of functions exported from the PM 37 and constants according to present exemplary embodiment. Only the functions relating to the present exemplary embodiment will be described below. The LM 36 calls a PM_GetPrinterDataFromPort( ) function. The LM 36 calls this function when the class driver 38 for a device (e.g., the printer 3) is controlled to obtain the state of a communication interface (e.g., the USB interface 4 or the Bluetooth interface 9) of the device (e.g., the printer 3). Furthermore, the LM 36 calls this function when the class driver 38 of the device (i.e., the printer 3) is controlled to control the I/O. An argument Control ID of the function sets an I/O control code so that the control allocated to each I/O control code can be performed.

The LPWSTR is a pointer indicating a Unicode character string ending by NULL. An argument lpOutBuffer sets obtained information when the function is returned. The lpOutBuffer is a pointer variable of a Unicode character string ending by NULL (i.e., a variable representing an address of *lpOutBuffer). The data referred to by the *lpOutBuffer represents a memory value in an address of the lpOutBuffer.

The IOCTL_BLUETOOTH_COMMUNICATION is the definition of an I/O control code provided in the present exemplary embodiment, to which the control for confirming a state of the communication link (ACL and HCRP) of the Bluetooth communications is allocated. Furthermore, each of BLUETOOTH_CONNECTED, BLUETOOTH_RECOVERED, BLUETOOTH_DISCONNECTED, and BLUETOOTH_UNKNOWN is the definition of I/O control codes provided in the present exemplary embodiment. The aforementioned definitions represent the following four states of the communication link for the Bluetooth communications.

BLUETOOTH_CONNECTED: a normal state where the communication link for the Bluetooth communications is established.

BLUETOOTH_RECOVERED: a state where the communication link is returned to a normal state in response to the recovery of the Bluetooth communications.

BLUETOOTH_DISCONNECTED: a state where the communication link for the Bluetooth communications is disconnected.

BLUETOOTH_UNKNOWN: a state where establishment or disconnection of the communication link for the Bluetooth communications is unknown.

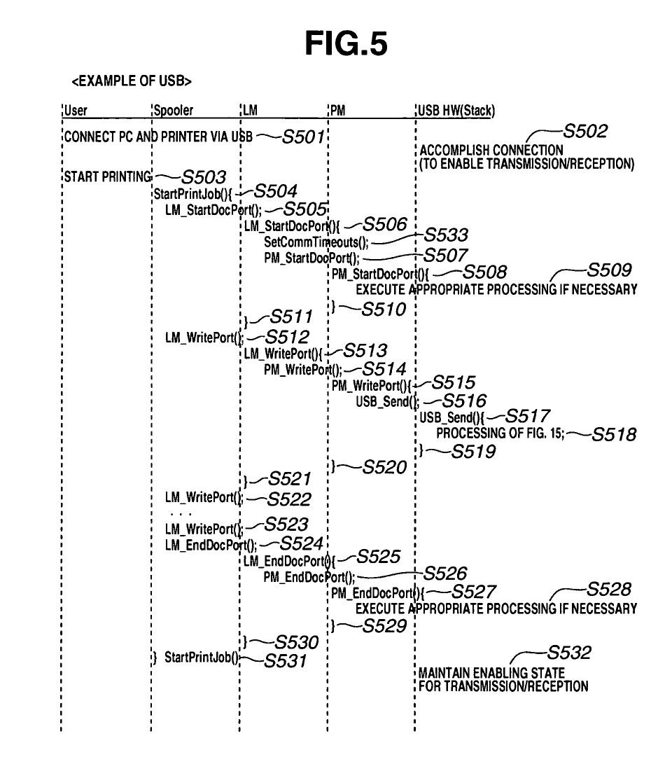

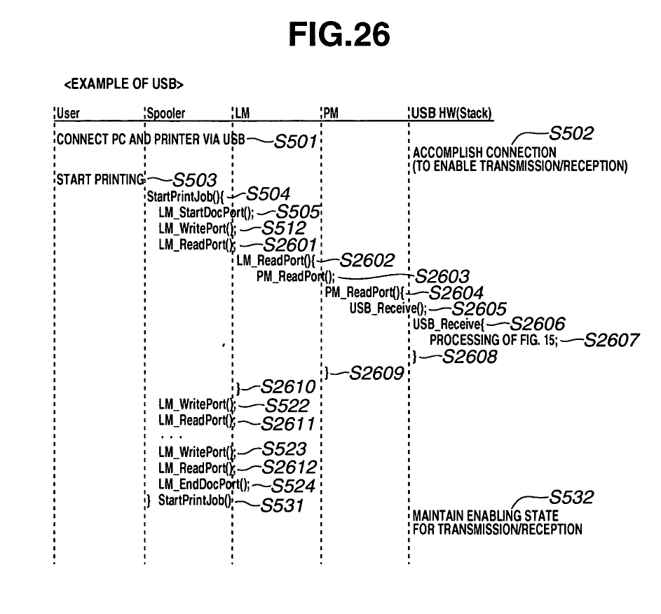

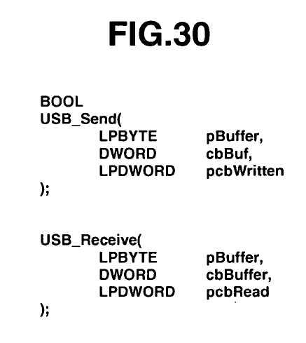

FIG. 30 is a view showing the definition of functions exported from the USB HW (Stack). Although FIGS. 5 and 26 illustrate the PM 37 calling these functions, these functions are actually called by the class driver 38 (not shown).

A USB_Send( ) function is called when command data, such as a print start command, a print control command, and a print termination command, is transmitted to the printer 3. An argument pBuffer of this function sets the data to be transmitted to the printer 3. An argument cbBuf sets the size of the data (units: byte).

The LPDWORD is a pointer indicating an unsigned double word (unsigned long, 32 bits). An argument pcbWritten sets the size of data actually transmitted to the printer 3 when the function is returned. The pcbWritten is a pointer variable of an unsigned double word (i.e., a variable representing an address of *pcbWritten). The data referred to by the *pcbWritten represents a memory value in an address of the pcbWritten.

A USB_Receive( ) function is called when the status monitor obtains a status control command from the printer 3. An argument pBuffer of this function sets the data transmitted from the printer 3 that is actually obtained by the PC 1 when the function is returned. An argument pcbRead sets the size of the data. The pcbRead is a pointer variable of an unsigned double word (i.e., a variable representing an address of *pcbRead). The data referred to by the *pcbRead represents a memory value in an address of the pcbRead.

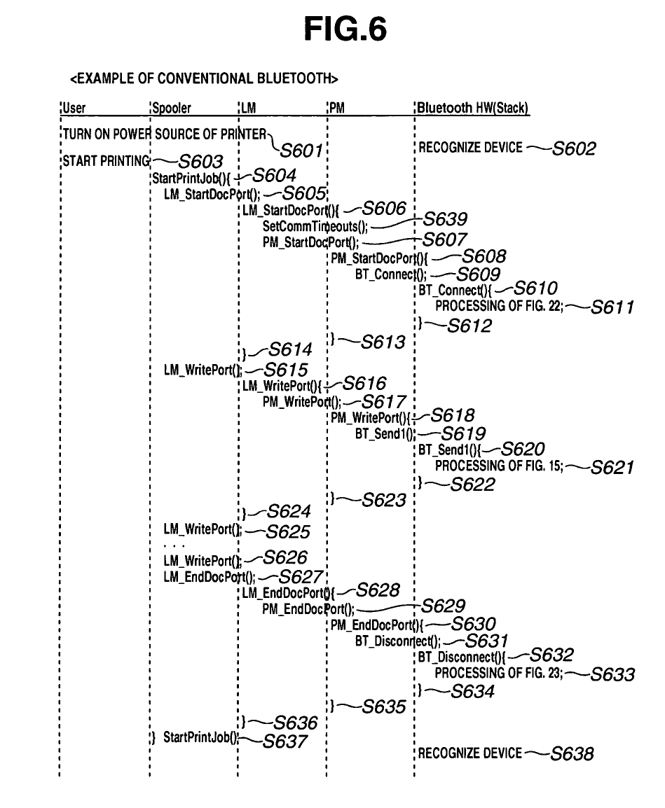

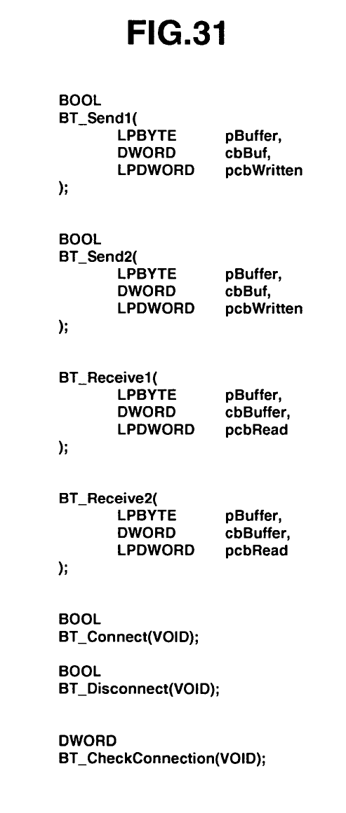

FIG. 31 is a view showing the definition of functions exported from the Bluetooth HW (Stack). Although FIGS. 6, 7, 24, and 25 illustrate the PM 37 calling these functions, these functions are actually called by the class driver 38 (not shown)

A BT_Send1( ) function and a BT_Send2( ) function are called when command data, such as a print start command, a print control command, and a print termination command, is transmitted to the printer 3. An argument pBuffer of these functions sets the data transmitted to the printer 3. An argument cbBuf sets the size of the data (units: byte). The LPDWORD is a pointer indicating an unsigned double word (unsigned long, 32 bits). An argument pcbWritten sets the size of data actually transmitted to the printer 3 when these functions are returned. The pcbWritten is a pointer variable of an unsigned double word (i.e., a variable representing an address of *pcbWritten). The data referred to by the *pcbWritten represents a memory value in an address of the pcbWritten.

A BT_Receive1( ) function and a BT_Receive2( ) function are called when the status monitor obtains a status control command from the printer 3. An argument pBuffer of these functions sets the data transmitted from the printer 3 that is actually obtained by the PC 1 when these functions are returned. An argument pcbRead sets the size of the data. The pcbRead is a pointer variable of an unsigned double word (i.e., a variable representing an address of *pcbRead). The data referred to by the *pcbRead represents a memory value in an address of the pcbRead.

A BT_Connect( ) function is called when the communication link (ACL and HCRP) of Bluetooth communications is established. A BT_Disconnect( ) function is called when the communication link (ACL and HCRP) of Bluetooth communications is disconnected. A BT_CheckConnection( ) function is called when a state of the communication link (ACL and HCRP) of Bluetooth communications is confirmed.

FIG. 5 is a function flow showing an exemplary printing operation performed via the USB interface 4. It is noted that FIG. 5 omits some processing, such as return processing for returning TRUE representing success of the function, part of error processing, and processing of the class driver 38.

The uppermost level shows the executor of each processing, in which the column of User represents the operation (processing) by a user, the column of Spooler represents the processing of the Spooler of the Windows (registered trademark) XP OS described in FIG. 4, the column of LM represents the processing of the LM 36, the column of PM represents the processing of the PM 37, and the column of USB HW (Stack) represents the processing of a hardware or firmware stack of the USB port 5. For example, the column of User includes user's operation (processing) such as “connect PC and printer via USB.” Other columns represent the processing of respective executors.

In FIG. 5, when a user connects the PC 1 and the printer 3 via the USB interface 4 (refer to step S501), USB connection is accomplished in the processing of the USB HW (Stack) to enable transmission/reception of data (refer to step S502). When the user starts a printing operation (refer to step S503), the Spooler executes a StartPrintJob( ) function (refer to step S504).

When the StartPrintJob( ) function is executed (refer to step S504), the Spooler calls the LM_StartDocPort( ) function in the LM 36 (refer to step S505). When the LM_StartDocPort( ) function is executed (refer to step S506), the Spooler calls a SetCommTimeouts( ) function, which is one of standard functions of the OS, and sets Write/Read time-out times in the USB communications (refer to step S533), as follows.

Write time-out time: 3 seconds

Read time-out time: 1 second

After accomplishing step S533, the LM 36 calls the PM_StartDocPort( ) function in the PM 37 (refer to step S507). When the PM_StartDocPort( ) function is executed (refer to step S508), the PM 37 executes appropriate processing if necessary (refer to step S509). For example, the processing includes initialization of variables in the PM 37 and the USB HW (Stack), although the details of the processing are not described. After accomplishing step S509, the PM 37 returns the PM_StartDocPort( ) function to the LM 36 (refer to step S510) and the LM 36 returns the LM_StartDocPort( ) function to the Spooler (refer to step S511).

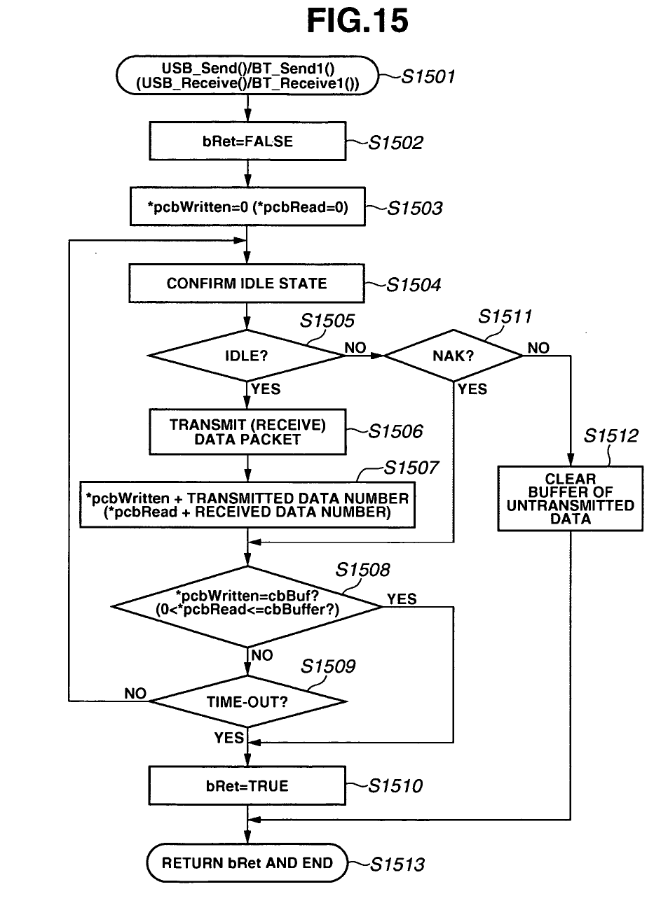

Then, the Spooler calls the LM_WritePort( ) function in the LM 36, in the processing of StartPrintJob( ) function (refer to step S512). In this case, the pBuffer shown in FIG. 27 includes a print start command, and the cbBuf sets the size of the print start command (units: byte). When the LM_WritePort( ) function is executed (refer to step S513), the LM 36 calls the PM_WritePort( ) function in the PM 37 (refer to step S514). When the PM_WritePort( ) function is executed (refer to step S515), the PM 37 calls the USB_Send( ) function in the USB HW (Stack) (refer to step S516). When the USB_Send( ) function is executed (refer to step S517), the processing described in FIG. 15 is executed (refer to step S518). The USB HW (Stack) returns the USB_Send( ) function to the PM 37 (refer to step S519). When the USB_Send( ) function ends in success, the printer 3 receives the print start command and shifts its operation into the print control mode.

After accomplishing step S519, the PM 37 returns the PM_WritePort( ) function to the LM 36 (refer to step S520) and the LM 36 returns the LM_WritePort( ) function to the Spooler (refer to step S521). Then, the Spooler calls the LM_WritePort( ) function including a print control command representing print image data (which is set in the argument pBuffer) (refer to step S522). Subsequently, the processing of the LM_WritePort( ) function is executed in the same manner as the processing described in step S513.

When the LM_WritePort( ) function ends in success, the printer 3 receives the print control command and executes a recording output (print) operation according to the command. When the transmission of the print control command representing the print image data is entirely accomplished, the Spooler calls the LM_WritePort( ) function including a print termination command (which is set in the argument pBuffer) (refer to step S523). When the LM_WritePort( ) function ends in success, the printer 3 receives the print termination command and shifts its operation into the neutral mode. Then, the LM_EndDocPort( ) function in the LM 36 is called (refer to step S524). When the LM_EndDocPort( ) function is executed (refer to step S525), the LM 36 calls the PM_EndDocPort( ) function in the PM 37 (refer to step S526).

When the PM_EndDocPort( ) function is executed (refer to step S527), the PM 37 executes appropriate processing if necessary (refer to step S528). For example, the processing includes initialization in response to an error termination, although the details of the processing are not described. After accomplishing step S528, the PM_EndDocPort( ) function is returned to the LM 36 (refer to step S529). The LM_EndDocPort( ) function is returned to the Spooler (refer to step S530). Then, the Spooler terminates the StartPrintJob( ) function (refer to step S531). When a printing operation is normally terminated, the USB HW (Stack) maintains an enabling state for data transmission/reception (refer to step S532).

FIG. 6 is a function flow showing a conventional printing operation performed via the Bluetooth interface 9. It is noted that FIG. 6 omits some processing, such as return processing for returning TRUE representing success of the function, part of error processing, and processing of the class driver 38.

FIG. 6 shows the executor of each processing, in which the column of User represents the operation (processing) by a user, the column of Spooler represents the processing of the Spooler of the Windows (registered trademark) XP OS described in FIG. 4, the column of LM represents the processing of the LM 36, the column of PM represents the processing of the PM 37, and the column of Bluetooth HW (Stack) represents the processing of a hardware or firmware stack of the Bluetooth port 7. For example, the column of User includes user's operation (processing) such as “turn on power source of printer.” Other columns represent the processing of respective executors.

In FIG. 6, when a user turns on the power source of the printer 3 (refer to step S601), the Bluetooth HW (Stack) recognizes a device (i.e., the printer 3) (refer to step S602). When the user starts a printing operation (refer to step S603), the Spooler executes the StartPrintJob( ) function (refer to step S604). When the StartPrintJob( ) function is executed (refer to step S604), the Spooler calls the LM_StartDocPort( ) function in the LM 36 (refer to step S605). When the LM_StartDocPort( ) function is executed (refer to step S606), the LM 36 calls the SetCommTimeouts( ) function which is one of standard functions of the OS, and sets Write/Read time-out times in the Bluetooth communications (refer to step S639), as follows.

Write time-out time: 3 seconds

Read time-out time: 1 second

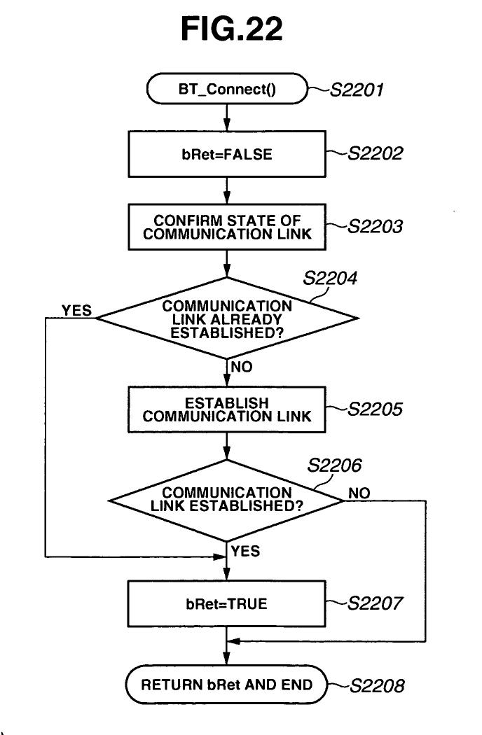

After accomplishing step S639, the LM 36 calls the PM_StartDocPort( ) function in the PM 37 (refer to step S607). When the PM_StartDocPort( ) function is executed (refer to step S608), the PM 37 calls the BT_Connect( ) function in the Bluetooth HW (Stack) (refer to step S609). When the BT_Connect( ) function is executed (refer to step S610), the Bluetooth HW (Stack) executes the processing described in FIG. 22 (refer to step S611). The Bluetooth HW (Stack) returns the BT_Connect( ) function to the PM 37 (refer to step S612). Then, the PM 37 returns the PM_StartDocPort( ) function to the LM 36 (refer to step S613). The LM 36 returns the LM_StartDocPort( ) function to the Spooler (refer to step S614). The Spooler calls the LM_WritePort( ) function in LM 36, in the processing of StartPrintJob( ) function (refer to step S615). In this case, the argument pBuffer shown in FIG. 27 includes the print control command and the cbBuf sets the size of the print control command (units: byte).

When the LM_WritePort( ) function is executed (refer to step S616), the LM 36 calls the PM_WritePort( ) function in the PM 37 (refer to step S617). When the PM_WritePort( ) function is executed (refer to step S618), the PM 37 calls the BT_Send1( ) function in the Bluetooth HW (Stack) (refer to step S619). When the BT_Send1( ) function is executed (refer to step S620), the Bluetooth HW (Stack) executes the processing described in FIG. 15 (refer to step S621). Then, the Bluetooth HW (Stack) returns the BT_Send1( ) function to the PM 37 (refer to step S622).

When the BT_Send1( ) function is returned, the PM 37 returns the PM_WritePort( ) function to the LM 36 (refer to step S623) and the LM 36 returns the LM_WritePort( ) function to the Spooler (refer to step S624). Then, the Spooler calls the LM_WritePort( ) function including a print control command representing print image data (which is set in the argument pBuffer) (refer to step S625). Subsequently, the processing of the LM_WritePort( ) function is executed in the same manner as the processing described in step S616.

When the LM_WritePort( ) function ends in success, the printer 3 receives the print control command and executes a recording output (print) operation according to the command. When the transmission of the print control command representing the print image data is entirely accomplished, the Spooler calls the LM_WritePort( ) function including a print termination command (which is set in the argument pBuffer) (refer to step S626). When the LM_WritePort( ) function ends in success, the printer 3 receives the print termination command and shifts its operation into the neutral mode. Then, the LM_EndDocPort( ) function in the LM 36 is called (refer to step S627). When the LM_EndDocPort( ) function is executed (refer to step S628), the LM 36 calls the PM_EndDocPort( ) function in the PM 37 (refer to step S629).

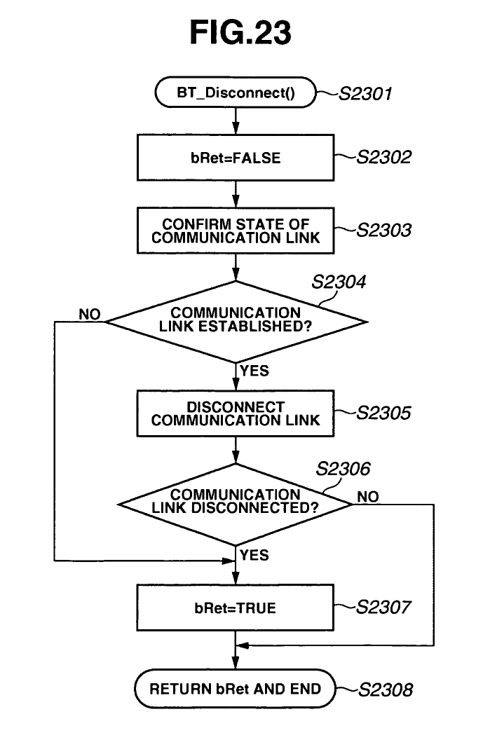

When the PM_EndDocPort( ) function is executed (refer to step S630), the PM 37 calls the BT_Disconnect( ) function in the Bluetooth HW (Stack) (refer to step S631). When the BT_Disconnect( ) function is executed (refer to step S632), the Bluetooth HW (Stack) executes the processing described in FIG. 23 (refer to step S633). Then, the Bluetooth HW (Stack) returns the BT_Disconnect( ) function to the PM 37 (refer to step S634) and the PM 37 returns the PM_EndDocPort( ) function to the LM 36 (refer to step S635). When the PM_EndDocPort( ) function is returned, the LM 36 returns the LM_EndDocPort( ) function to the Spooler (refer to step S636). The Spooler terminates the StartPrintJob( ) function (refer to step S637). When the printing operation is normally terminated, the Bluetooth HW (Stack) maintains the state where the device (printer 3) is recognized (refer to step S638).

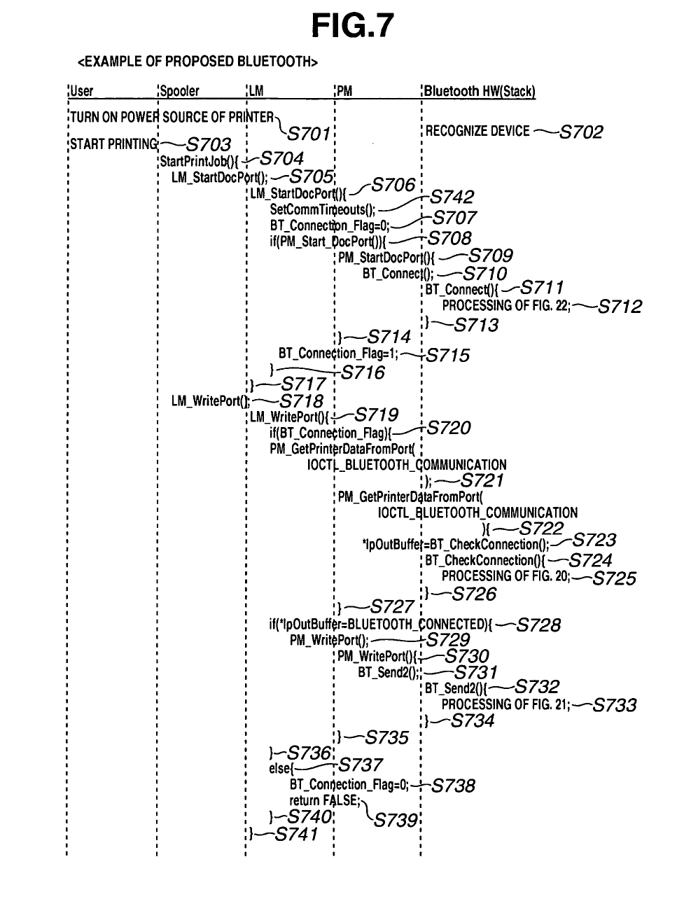

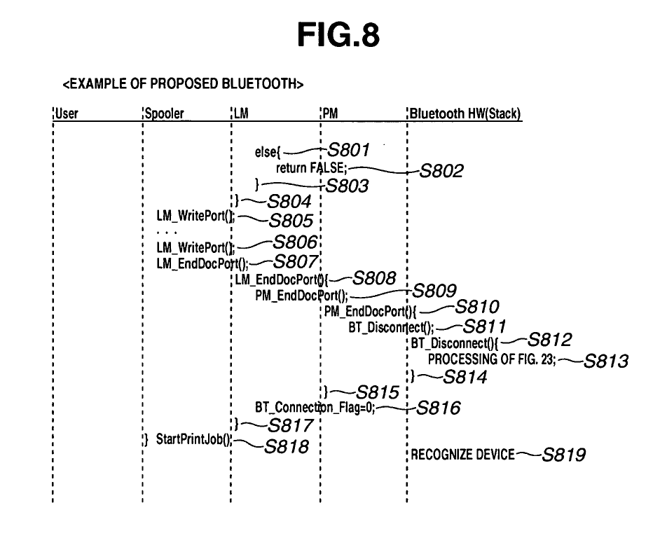

FIGS. 7 and 8 are function flows each showing an exemplary printing operation performed via the Bluetooth interface 9 according to the present exemplary embodiment. It is noted that FIGS. 7 and 8 omit some processing, such as return processing for returning TRUE representing success of the function, part of error processing, and processing of the class driver 38.

In FIGS. 7 and 8, the uppermost level shows the executor of each processing. The column of User represents the operation (processing) by a user. The column of Spooler represents the processing of the Spooler of the Windows (registered trademark) XP OS described in FIG. 4. The column of LM represents the processing of the LM 36. The column of PM represents the processing of the PM 37. And, the column of Bluetooth HW (Stack) represents the processing of a hardware or firmware stack of the Bluetooth port 7. For example, the column of User includes user's operation (processing) such as “turn on power source of printer.” Other columns represent the processing of respective executors.

In FIG. 7, when a user turns on the power source of the printer 3 (refer to step S701), the Bluetooth HW (Stack) recognizes a device (i.e., the printer 3) (refer to step S702). When the user starts a printing operation (refer to step S703), the Spooler executes the StartPrintJob( ) function (refer to step S704). When the StartPrintJob( ) function is executed (refer to step S704), the Spooler calls the LM_StartDocPort( ) function in the LM 36 (refer to step S705). When the LM_StartDocPort( ) function is executed (refer to step S706), the LM 36 calls the SetCommTimeouts( ) function which is one of standard functions of the OS, and sets Write/Read time-out times for the Bluetooth communications (refer to step S742), as follows.

Write time-out time: 3 seconds

Read time-out time: 1 second

After accomplishing step S742, the LM 36 performs initialization by clearing a communication connection flag representing a connection state of the Bluetooth communications, i.e., BT_Connection_Flag=0 (refer to step S707) and calls the PM_StartDocPort( ) function in the PM 37 (refer to step S708). When the PM_StartDocPort( ) function is executed (refer to step S709), the PM 37 calls the BT_Connect( ) function in the Bluetooth HW (Stack) (refer to step S710). When the BT_Connect( ) function is executed (refer to step S711), the Bluetooth HW (Stack) executes the processing described in FIG. 22 (refer to step S712). Then, the BT_Connect( ) function is returned to the PM 37 (refer to step S713) and the PM_StartDocPort( ) function is returned to the LM 36 (refer to step S714).

When the PM_StartDocPort( ) function called in step S708 ends in success, the LM 36 sets a communication connection flag representing a connection state of the Bluetooth communications, i.e., BT_Connection_Flag=1 (refer to step S715). Furthermore, the LM 36 terminates the processing of step S708 (refer to step S716). The LM_StartDocPort( ) function is returned to the Spooler (refer to step S717). The Spooler calls the LM_WritePort( ) function in the LM 36 in the processing of the StartPrintJob( ) function (refer to step S718). In this case, the argument pBuffer shown in FIG. 27 includes the print control command and the cbBuf sets the size of the print control command (units: byte). When the LM_WritePort( ) function is executed (refer to step S719) and the communication connection flag is set, i.e., BT_Connection_Flag=1 (refer to step S720), the LM 36 sets IOCTL_BLUETOOTH_COMMUNICATION in the argument Control ID (refer to FIG. 29). Furthermore, the LM 36 calls the PM_GetPrinterDataFromPort( ) function in the PM 37 (refer to step S721).

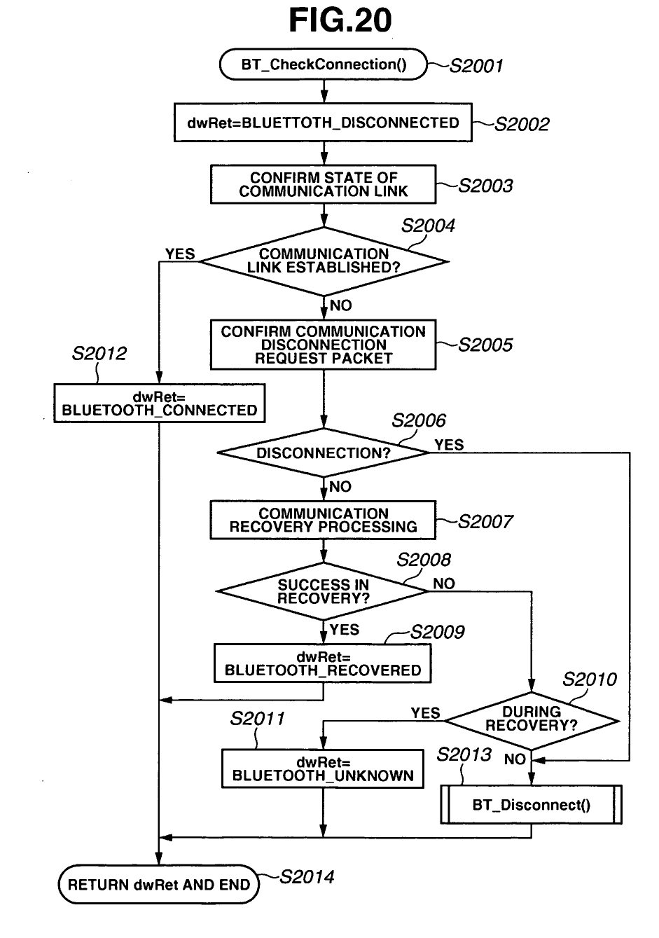

When the PM_GetPrinterDataFromPort( ) function is executed (refer to step S722), the PM 37 calls the BT_CheckConnection( ) function in the Bluetooth HW (Stack) (refer to step S723). When the BT_CheckConnection( ) function is executed (refer to step S724), the Bluetooth HW (Stack) executes the processing described in FIG. 20 (refer to step S725). Then, the BT_CheckConnection( ) function is returned to the PM 37 (refer to step S726). The returned value is substituted for the *lpOutBuffer shown in FIG. 29 and the PM_GetPrinterDataFromPort( ) function is returned to the LM 36 (refer to step S727). When the value of the *lpOutBuffer is equal to BLUETOOTH_CONNECTED (refer to step S728), the LM 36 calls the PM_WritePort( ) function in the PM 37 (refer to step S729). Namely, when the value of the *lpOutBuffer shows a normal state where the communication link for the Bluetooth communications is established, the LM 36 calls the PM_WritePort( ) function in the PM 37 (refer to step S729).

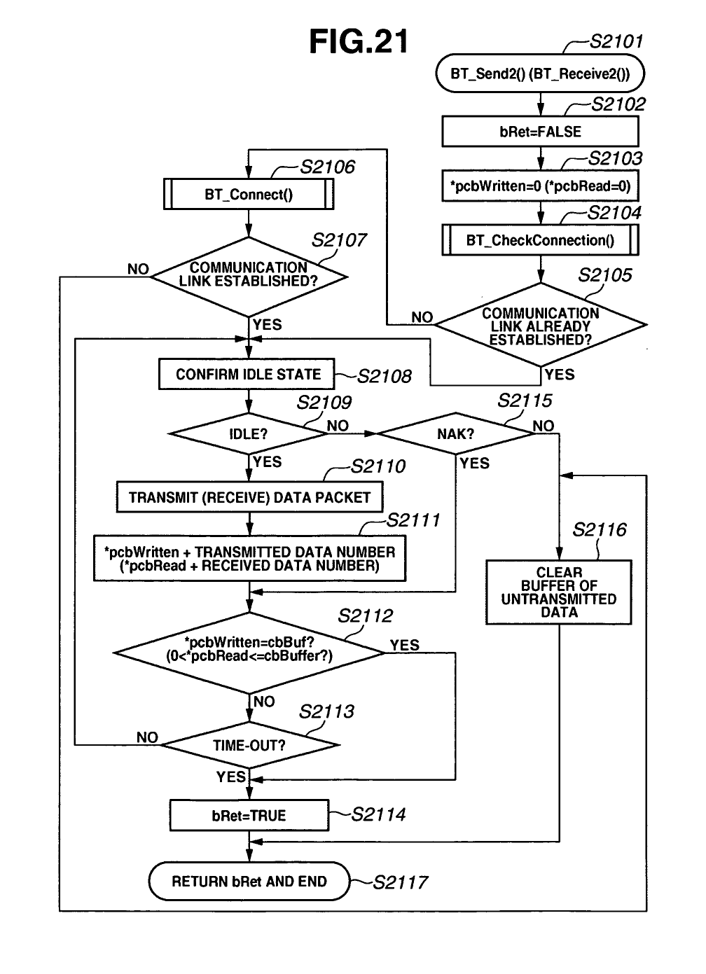

When the PM_WritePort( ) function is executed (refer to step S730), the PM 37 calls the BT_Send2( ) function in the Bluetooth HW (Stack) (refer to step S731). When the BT_Send2( ) function is executed (refer to step S732), the Bluetooth HW (Stack) executes the processing described in FIG. 21 (refer to step S733). Then, the BT_Send2( ) function is returned to the PM 37 (refer to step S734) and the PM_WritePort( ) function is returned to the LM 36 (refer to step S735). The processing flow returns to step S728.

In step S728, if the value of the *lpOutBuffer is not equal to the BLUETOOTH_CONNECTED, it is determined that the communication state is abnormal and the processing of step S728 is terminated (refer to step S736). The processing flow proceeds to step S737. When the processing of step S737 is started, the LM 36 clears the communication connection flag, i.e., BT_Connection_Flag=0 (refer to step S738), and returns FALSE representing failure to the Spooler (refer to step S739). Then, the processing of step S737 is terminated (refer to step S740), and the processing flow returns to step S720. In step S720, if the communication connection flag is cleared, i.e., BT_Connection_Flag=0, the LM 36 terminates the processing of step S720 (refer to step S741) and proceeds to step S801 of FIG. 8.

Now referring to FIG. 8, when the processing of step S801 is started, the LM 36 returns FALSE representing failure to the Spooler (refer to step S802) and terminates the processing of step S801 (refer to step S803). The LM_WritePort( ) function is returned to the Spooler (refer to step S804). After the LM_WritePort( ) function of step S718 ends in success, the Spooler calls the LM_WritePort( ) function including a print control command representing print image data (which is set in the argument pBuffer) (refer to step S805). Subsequently, the processing of the LM_WritePort( ) function is executed in the same manner as the processing described in step S719. When the LM_WritePort( ) function ends in success, the printer 3 receives the print control command and executes a recording output (print) operation according to the command.

When the transmission of the print control command representing the print image data is entirely accomplished, the Spooler calls the LM_WritePort( ) function including a print termination command (which is set in the argument pBuffer) (refer to step S806). When the LM_WritePort( ) function ends in success, the printer 3 receives the print termination command and shifts its operation into the neutral mode. Then, the Spooler calls the LM_EndDocPort( ) function in the LM 36 (refer to step S807). After the LM_EndDocPort( ) function is executed (refer to step S808), the LM 36 calls the PM_EndDocPort( ) function in the PM 37 (refer to step S809). After the PM_EndDocPort( ) function is executed (refer to step S810), the PM 37 calls the BT_Disconnect( ) function in the Bluetooth HW (Stack) (refer to step S811).

After the BT_Disconnect( ) function is executed (refer to step S812), the Bluetooth HW (Stack) executes the processing which is later described in FIG. 23 (refer to step S813). The BT_Disconnect( ) function is returned to the PM 37 (refer to step S814). When the BT_Disconnect( ) function is returned, the PM 37 returns the PM_EndDocPort( ) function to the LM 36 (refer to step S815). The LM 36 performs initialization by clearing a communication connection flag representing a connection state of the Bluetooth communications, i.e., BT_Connection_Flag=0 (refer to step S816). Then, the LM_EndDocPort( ) function is returned to the Spooler (refer to step S817), and the Spooler terminate the StartPrintJob( ) function (refer to step S818).

When the printing operation is normally terminated, the Bluetooth HW (Stack) maintains the state where the device (i.e., the printer 3) is recognized (refer to step S819). In steps S739 and S802, if FALSE representing failure is returned, a returned value of the LM_WritePort( ) function in the LM 36 becomes FALSE. This value is returned to the StartPrintJob( ) function in the Spooler. Thus, in the succeeding processing, the StartPrintJob( ) function in the Spooler does not call the LM_WritePort( ) function in the LM 36. As a result, the print job ends in failure.

Accordingly, for example when that the printer 3 is performing a printing operation in the print control mode, the communication link may be disconnected due to deteriorated radio wave conditions. In such a case, radio wave conditions may be improved later after the printer 3 once shifts its operation from the print control mode to the neutral mode. However, the print control command is no longer transmitted in the succeeding processing. Thus, the printer 3 does not cause any malfunction including incorrect print.

As described above, in step S721, the LM 36 calls the PM_GetPrinterDataFromPort( ) function in the PM 37 and confirms the returned value set in the *lpOutBuffer. When the returned value is equal to BLUETOOTH_CONNECTED representing a normal state where the communication link for the Bluetooth communications is establish, the LM 36 calls the PM_WritePort( ) function in the PM 37.

Then, the LM 36 transmits the command data, such as a print start command, a print control command, and a print termination command. When the returned value is different from BLUETOOTH_CONNECTED, the LM 36 determines that the communication state is abnormal and returns FALSE representing failure to the upper function. Thus, the print job ends in failure. Occurrence of incorrect print or other malfunction can be prevented and/or reduced.

As described above, in addition to a later-described confirmation unit for confirming a communication state of the communication link of the Bluetooth HW (Stack) for the Bluetooth communications (refer to FIGS. 15 and 21), a confirmation unit for confirming a communication state of the communication link of the LM 36 having a different processing logic is provided. The printer driver 50 can use the provided communication state confirmation unit to realize a safe transmission of data from the PC 1 to the printer 3.

FIG. 32 is a view showing an example of the status monitor that monitors the state of the printer 3. In the present exemplary embodiment, the status monitor shown in FIG. 32 is the application 30 installed on the PC 1. In FIG. 32, a main window 201 of the status monitor shows a present state of the printer 3 (i.e., a printer having a model name “kmmn” manufactured by XYZ Corporation).

A display section 202 displays printer information that shows the printer 3 is in an online state. A display section 203 displays ink information that shows the information relating to inks used in the printer 3. A bar graph 204 displays a residual amount of each ink. According to the ink information in FIG. 32, the printer 3 uses four types of color inks, i.e., black, yellow, magenta, and cyan inks. The residual amounts of four color inks are 80%, 50%, 0% (empty), and 100% (full), respectively. The status monitor receives a status control command from the printer 3 by performing polling at intervals of 5 seconds. The status monitor updates its state display based on the status control command to provide a real time state display of the printer 3.

According to the Bluetooth or similar wireless communications, the PC 1 executes polling at intervals of, for example, 5 seconds to receive a status control command and updates the state display of the printer 3. If the radio wave conditions for the Bluetooth communications are deteriorated, it will be unclear whether the communication link is established or disconnected. In such a case, reception of the status control command is repetitively tried by performing polling. More specifically, the hardware or firmware (Bluetooth port 7), which controls the Bluetooth communications, retries reception of the status control command. When no status control command is received from the printer 3 as a result of such retry processing, the status monitor can receive no result of processing. Hence, the status monitor is brought into an uncontrollable state.

FIG. 26 is a function flow showing an exemplary printing operation performed via the USB interface 4 in a condition that the status monitor of FIG. 32 is activated. It is noted that FIG. 26 omits some processing, such as return processing for returning TRUE representing success of the function, part of error processing, and processing of the class driver 38.

In FIG. 26, the uppermost level shows the executor of each processing. The column of User represents the operation (processing) by a user. The column of Spooler represents the processing of the Spooler of the Windows (registered trademark) XP OS described in FIG. 4. The column of LM represents the processing of the LM 36. The column of PM represents the processing of the PM 37. And, the column of USB HW (Stack) represents the processing of a hardware or firmware stack of the USB port 5. For example, the column of User includes user's operation (processing) such as “connect PC and printer via USB.” Other columns represent the processing of respective executors. In FIG. 26, the processing similar to the processing described in FIG. 5 is denoted by using the same step number(s) used in FIG. 5 and not described again.

In FIG. 26, when a user connects the PC 1 and the printer 3 via the USB interface 4 (refer to step S501), the USB HW (Stack) accomplishes the USB connection to provide a state enabling transmission/reception of data (refer to step S502). When the user starts a printing operation (refer to step S503), the Spooler executes the StartPrintJob( ) function (refer to step S504). When the StartPrintJob( ) function is executed (refer to step S504), the Splooer calls the LM_StartDocPort( ) function in the LM 36 (refer to step S505) and calls the LM_WritePort( ) function in the LM 36 (refer to step S512). In this case, the pBuffer shown in FIG. 27 includes a print start command and the cbBuf sets the size of the print start command (units: byte).

When a print job includes a Read request as an interrupt resulting from polling of the status monitor of FIG. 32 performed at intervals of 5 seconds, the Spooler calls the LM_ReadPort( ) function in the LM 36 (refer to step S2601). When the LM_ReadPort( ) function is executed (refer to step S2602), the LM 36 calls the PM_ReadPort( ) function in the PM 37 (refer to step S2603). When the PM_ReadPort( ) function is executed (refer to step S2604), the PM 37 calls the USB_Receive( ) function in the USB HW (Stack) (refer to step S2605). When the USB_Receive( ) function is executed (refer to step S2606), the USB HW (Stack) executes the processing described in FIG. 15 (refer to step S2607) and returns the USB_Receive( ) function to the PM 37 (refer to step S2608).

When the USB_Receive( ) function is returned, the PM_ReadPort( ) function is returned to the LM 36 (refer to step S2609) and the LM_ReadPort( ) function is returned to the Spooler (refer to step S2610). In this case, the status control command transmitted from the printer 3 to the PC 1 is stored in the pBuffer of the LM_ReadPort( ) function shown in FIG. 27 and its size (units: byte) is set in the cbBuffer. Then, the status control command is returned to the status monitor of FIG. 32. The status monitor of FIG. 32 updates the state display according to the status control command. The succeeding processing of the LM_ReadPort( ) function is similar to the processing described in step S2402. After the LM_WritePort( ) function of step S512 ends in success, the Spooler calls the LM_WritePort( ) function including a print control command representing print image data (which is set in the argument pBuffer) (refer to step S522). When the print job includes a Read request as an interrupt resulting from polling of the status monitor of FIG. 32 performed at intervals of 5 seconds, the Spooler calls the LM_ReadPort( ) function in the LM 36 (refer to step S2611).

When the transmission of the print control command representing the print image data is entirely accomplished, the Spooler calls the LM_WritePort( ) function including the print termination command (which is set in the argument pBuffer) (refer to step S523). When the print job includes a Read request as an interrupt resulting from polling of the status monitor of FIG. 32 performed at intervals of 5 seconds, the Spooler calls the LM_ReadPort( ) function in the LM 36 (refer to step S2612). Then, the Spooler calls the LM_EndDocPort( ) function in the LM 36 (refer to step S524) and terminates the StartPrintJob( ) function (refer to step S531). When the printing operation is normally terminated, the USB HW (Stack) maintains an enabling state for data transmission/reception (refer to step S532).

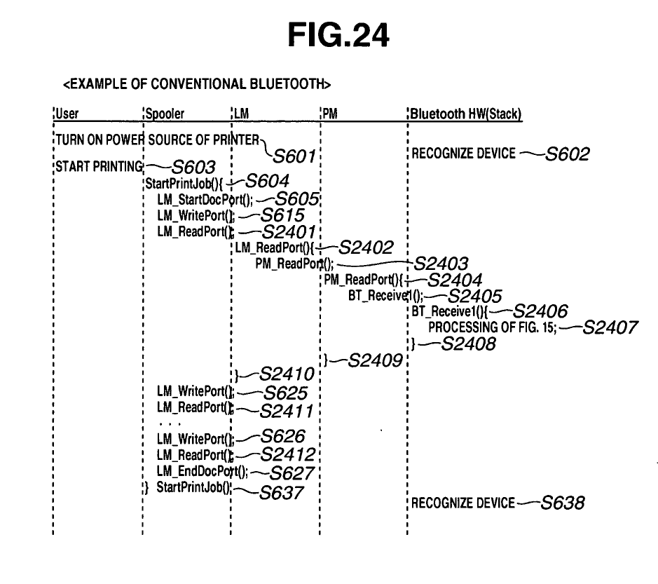

FIG. 24 is a function flow showing a conventional printing operation performed via the Bluetooth interface 9 in a condition that the status monitor of FIG. 32 is activated. It is noted that FIG. 24 omits some processing, such as return processing for returning TRUE representing success of the function, part of error processing, and processing of the class driver 38.

In FIG. 24, the uppermost level shows the executor of each processing. The column of User represents the operation (processing) by a user. The column of Spooler represents the processing of the Spooler of the Windows (registered trademark) XP OS described in FIG. 4. The column of LM represents the processing of the LM 36. The column of PM represents the processing of the PM 37. And, the column of Bluetooth HW (Stack) represents the processing of a hardware or firmware stack of the Bluetooth port 7. For example, the column of User includes user's operation (processing) such as “turn on power source of printer.” Other columns represent the processing of respective executors. In FIG. 24, the processing similar to the processing described in FIG. 6 is denoted by using the same step number(s) used in FIG. 6 and not described again.

In FIG. 24, when a user turns on the power source of the printer 3 (refer to step S601), the Bluetooth HW (Stack) recognizes a device (i.e., the printer 3) (refer to step S602). When the user starts a printing operation (refer to step S603), the Spooler executes the StartPrintJob( ) function (refer to step S604). When the StartPrintJob( ) function is executed (refer to step S604), the Spooler calls the LM_StartDocPort( ) function in the LM 36 (refer to step S605) and calls the LM_WritePort( ) function in the LM 36 (refer to step S615). In this case, the argument pBuffer shown in FIG. 27 includes the print control command and the cbBuf sets the size of the print control command (units: byte).

When the print job includes a Read request as an interrupt resulting from polling of the status monitor of FIG. 32 performed at intervals of 5 seconds, the Spooler calls the LM_ReadPort( ) function in the LM 36 (refer to step S2401). When the LM_ReadPort( ) function is executed (refer to step S2402), the LM 36 calls the PM_ReadPort( ) function in the PM 37 (refer to step S2403). When the PM_ReadPort( ) function is executed (refer to step S2404), the PM 37 calls the BT_Receive1( ) function in the Bluetooth HW (Stack) (refer to step S2405). When the BT_Receive1( ) function is executed (refer to step S2406), the Bluetooth HW (Stack) executes the processing which is later described in FIG. 15 (refer to step S2407) and returns the BT_Receive1( ) function to the PM 37 (refer to step S2408). When the BT_Receive1( ) function is returned, the PM_ReadPort( ) function is returned to the LM 36 (refer to step S2409) and the LM_ReadPort( ) function is returned to the Spooler (refer to step S2410).

In this case, the status control command transmitted from the printer 3 to the PC 1 is stored in the pBuffer of the LM_ReadPort( ) function shown in FIG. 27 and its size (units: byte) is set in the cbBuffer. Then, the status control command is returned to the status monitor of FIG. 32. The status monitor of FIG. 32 updates the state display according to the status control command. The succeeding processing of the LM_ReadPort( ) function is similar to the processing described in step S2402. After the LM_WritePort( ) function of step S615 ends in success, the Spooler calls the LM_WritePort( ) function including a print control command representing print image data (which is set in the argument pBuffer) (refer to step S625).

When the print job includes a Read request as an interrupt resulting from polling of the status monitor of FIG. 32 performed at intervals of 5 seconds, the Spooler calls the LM_ReadPort( ) function in the LM 36 (refer to step S2411). When the transmission of the print control command representing the print image data is entirely completed, the Spooler calls the LM_WritePort( ) function including a print termination command (which is set in the argument pBuffer) (refer to step S626). When the print job includes a Read request as an interrupt resulting from polling of the status monitor of FIG. 32 performed at intervals of 5 seconds, the Spooler calls the LM_ReadPort( ) function in the LM 36 (refer to step S2412) and calls the LM_EndDocPort( ) function in the LM 36 (refer to step S627). And, the Spooler terminates the StartPrintJob( ) function (refer to step S637). When the printing operation is normally terminated, the Bluetooth HW (Stack) maintains the state where the device (i.e., the printer 3) is recognized (refer to step S638).

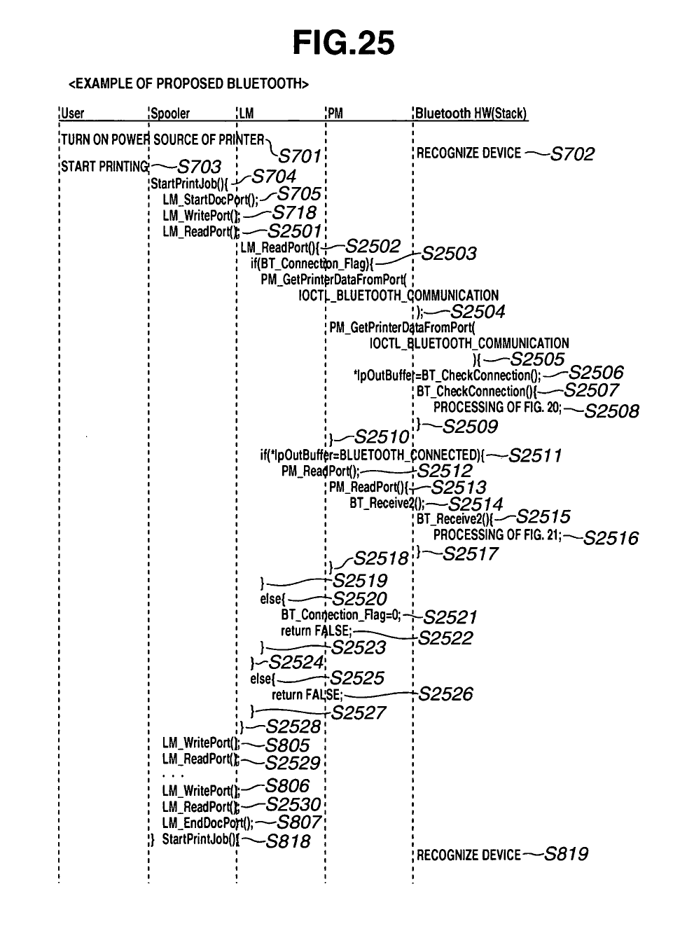

FIG. 25 is a function flow showing an exemplary proposed printing operation performed via the Bluetooth interface 9 according to the present exemplary embodiment in a condition where the status monitor of FIG. 32 is activated. It is noted that FIG. 25 omits some processing, such as return processing for returning TRUE representing success of the function, part of error processing, and processing of the class driver 38. In FIG. 25, the processing similar to the processing described in FIG. 7 or 8 is denoted by using the same step number(s) used in FIG. 7 or 8 and, therefore, they are not described again.

In FIG. 25, the uppermost level shows the executor of each processing. The column of User represents the operation (processing) by a user. The column of Spooler represents the processing of the Spooler of the Windows (registered trademark) XP OS described in FIG. 4. The column of LM represents the processing of the LM 36. The column of PM represents the processing of the PM 37. The column of Bluetooth HW (Stack) represents the processing of a hardware or firmware stack of the Bluetooth port 7. For example, the column of User includes user's operation (processing) such as “turn on power source of printer.” Other columns represent the processing of respective executors.

In FIG. 25, when a user turns on the power source of the printer 3 (refer to step S701), the Bluetooth HW (Stack) recognizes a device (i.e., the printer 3) (refer to step S702). When the user starts a printing operation (refer to step S703), the Spooler executes the StartPrintJob( ) function (refer to step S704). When the StartPrintJob( ) function is executed (refer to step S704), the Spooler calls the LM_StartDocPort( ) function in the LM 36 (refer to step S705) and calls the LM_WritePort( ) function in the LM 36 (refer to step S718). In this case, the argument pBuffer shown in FIG. 27 includes the print control command and the cbBuf sets the size of the print control command (units: byte).

When the print job includes a Read request as an interrupt resulting from polling of the status monitor of FIG. 32 performed at intervals of 5 seconds, the Spooler calls the LM_ReadPort( ) function in the LM 36 (refer to step S2501). When the LM_ReadPort( ) function is executed (refer to step S2502) and the communication connection flag is set, i.e., BT_Connection_Flag=1 (refer to step S2503), the LM 36 sets IOCTL_BLUETOOTH_COMMUNICATION in the Control ID (refer to FIG. 29) and calls the PM_GetPrinterDataFromPort( ) function in the PM 37 (refer to step S2504). When the PM_GetPrinterDataFromPort( ) function is executed (refer to step S2505), the PM 37 calls the BT_CheckConnection( ) function in the Bluetooth HW (Stack) (refer to step S2506).

When the BT_CheckConnection( ) function is executed (refer to step S2507), the Bluetooth HW (Stack) executes the processing described in FIG. 20 (refer to step S2508). The BT_CheckConnection( ) function is returned to the PM 37 (refer to step S2509), and the returned value is substituted for the *lpOutBuffer shown in FIG. 29 (refer to step S2506). Furthermore, the PM_GetPrinterDataFromPort( ) function is returned to the LM 36 (refer to step S2510). When the value of the *lpOutBuffer is equal to BLUETOOTH_CONNECTED representing a normal state where the communication link for the Bluetooth communications is established (refer to step S2511), the LM 36 calls the PM_ReadPort( ) function in the PM 37 (refer to step S2512). When the PM_ReadPort( ) function is executed (refer to step S2513), the PM 37 calls the BT_Receive2( ) function in the Bluetooth HW (Stack) (refer to step S2514). When the BT_Receive2( ) function is executed (refer to step S2515), the Bluetooth HW (Stack) executes the processing described in FIG. 21 (refer to step S2516). The BT_Receive2( ) function is returned to the PM 37 (refer to step S2517), and the PM_ReadPort( ) function is returned to the LM 36 (refer to step S2518). The processing flow returns to step S2511.

In step S2511, if the value of the *lpOutBuffer is not equal to the BLUETOOTH_CONNECTED, it is determined that the communication state is abnormal and the processing of step S2511 is terminated (refer to step S2519). The processing flow proceeds to step S2520. When the processing of step S2520 is started, the LM 36 clears the communication connection flag, i.e., BT_Connection_Flag=0 (refer to step S2521), and returns FALSE representing failure to the Spooler (refer to step S2522). Then, the processing of step S2520 is terminated (refer to step S2523), and the processing flow returns to step S2503.

In step S2503, if the communication connection flag is cleared, i.e., BT_Connection_Flag=0, the LM 36 terminates the processing of step S2503 (refer to step S2524) and proceeds to step S2525. When the processing of step S2525 is started, the LM 36 returns FALSE representing failure to the Spooler (refer to step S2526) and terminates the processing of step S2525 (refer to step S2527). The LM_ReadPort( ) function is returned (refer to step S2528). In this case, the status control command transmitted from the printer 3 to the PC 1 is stored in the pBuffer of the LM_ReadPort( ) function shown in FIG. 27 and its size (units: byte) is set in the cbBuffer. The status control command is returned to the status monitor of FIG. 32. The status monitor of FIG. 32 updates the state display according to the status control command. The succeeding processing of the LM_ReadPort( ) function is similar to the processing described in step S2502.

After the LM_WritePort( ) function of step S718 ends in success, the Spooler calls the LM_WritePort( ) function including a print control command representing print image data (which is set in the argument pBuffer) (refer to step S805). When the print job includes a Read request as an interrupt resulting from polling of the status monitor of FIG. 32 performed at intervals of 5 seconds, the Spooler calls the LM_ReadPort( ) function in the LM 36 (refer to step S2529). When the transmission of the print control command representing the print image data is entirely accomplished, the Spooler calls the LM_WritePort( ) function including a print termination command (which is set in the argument pBuffer) (refer to step S806). When the print job includes a Read request as an interrupt resulting from polling of the status monitor of FIG. 32 performed at intervals of 5 seconds, the Spooler calls the LM_ReadPort( ) function in the LM 36 (refer to step S2530). Then, the Spooler calls the LM_EndDocPort( ) function in the LM 36 (refer to step S807) and terminates the StartPrintJob( ) function (refer to step S818).

When the printing operation is normally terminated, the Bluetooth HW (Stack) maintains the state where the device (i.e., the printer 3) is recognized (refer to step S819). In steps S2522 and S2526, FALSE representing failure is returned to the Spooler, the returned value of the LM_ReadPort( ) function in the LM 36 becomes FALSE. This is returned to the StartPrintJob( ) function in the Spooler. In the succeeding processing, the StartPrintJob( ) function in the Spooler does not call the LM_ReadPort( ) function or the LM_WritePort( ) function in the LM 36. The print job ends in failure. Accordingly, for example when that the printer 3 is performing a printing operation in the print control mode, the communication link may be disconnected due to deteriorated radio wave conditions. In such a case, radio wave conditions may be improved later after the printer 3 once shifts its operation from the print control mode to the neutral mode. However, the print control command is no longer transmitted in the succeeding processing. Thus, the printer 3 does not cause any malfunction including incorrect print.

If the radio wave conditions for the wireless communications are deteriorated, it will be unclear whether the communication link is established or disconnected. In such a case, reception of the status control command is not tried by performing polling. Accordingly, it can be prevented and/or reduced that no status control command can be received from the printer 3 and the status monitor can receive no result of processing. Hence, the status monitor is not brought into an uncontrollable state.

As described above, in step S2504, the LM 36 calls the PM_GetPrinterDataFromPort( ) function in the PM 37 and confirms a returned value set in the *lpOutBuffer. When the returned value is equal to BLUETOOTH_CONNECTED representing a normal state where the communication link for the Bluetooth communications is established, the LM 36 calls the PM_ReadPort( ) function in the PM 37 and tries reception of the status control command. When the returned value is different from BLUETOOTH_CONNECTED, it is determined that communication state is abnormal and FALSE representing failure is returned to the upper function. The print job ends in failure. In the succeeding processing, reception of the status control command by polling is not tried.

Thus, occurrence of incorrect printing or other malfunction can be prevented and/or reduced. It can be prevented and/or reduced that no status control command can be received from the printer 3 and the status monitor can receive no result of processing. Hence, the status monitor is not brought into an uncontrollable state. As described above, in addition to a later-described confirmation unit for confirming a communication state of the communication link of the Bluetooth HW (Stack) for the Bluetooth communications (refer to FIGS. 15 and 21), a confirmation unit for confirming a communication state of the communication link of the LM 36 having a different processing logic is provided. The printer driver 50 can use the provided communication state confirmation unit to realize a safe transmission of data from the PC 1 to the printer 3 or vice versa.

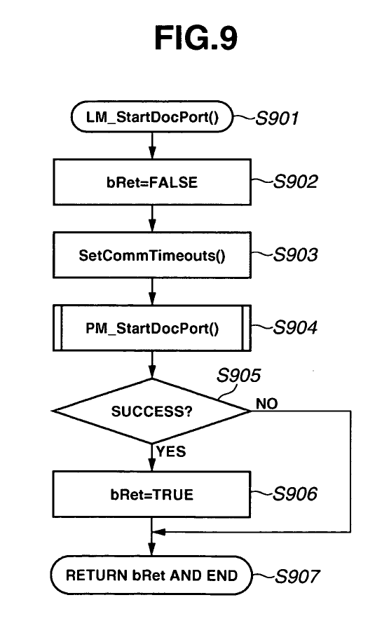

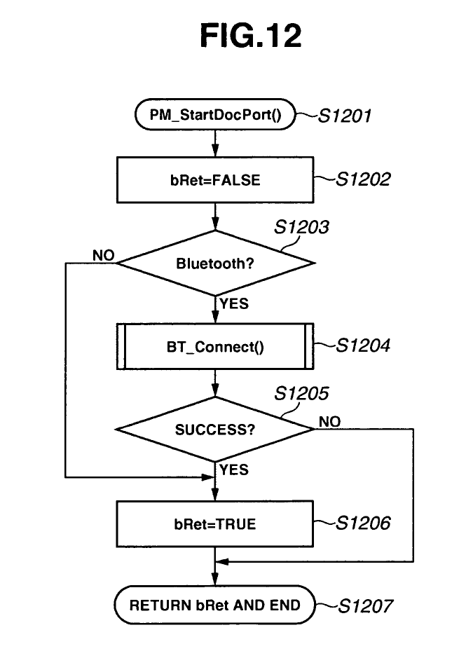

FIG. 9 is a flowchart showing conventional processing of the LM_StartDocPort( ) function in the LM 36 described with reference to FIGS. 5 and 6. When the LM 36 starts the LM_StartDocPort( ) function (refer to step S901), the LM 36 performs initialization by substituting the FALSE representing failure for the bRet (i.e., a returned value of the function) (refer to step S902). Then, the LM 36 calls the SetCommTimeouts( ) function and sets the Write/Read time-out times for the USB communications or Bluetooth communications (refer to step S903). Then, the LM 36 calls the PM_StartDocPort( ) function of the PM 37 described in FIG. 12 (refer to step S904). When the PM_StartDocPort( ) function ends in success and TRUE is returned from the PM 37 (refer to step S905), the LM 36 substitutes TRUE representing success for the bRet (refer to step S906) and returns the bRet to the Spooler before terminating the function (refer to step S907). In step S905, if the PM_StartDocPort( ) function ends in failure and the FALSE representing failure is returned, the processing flow proceeds to step S907 to return the bRet before terminating the function.

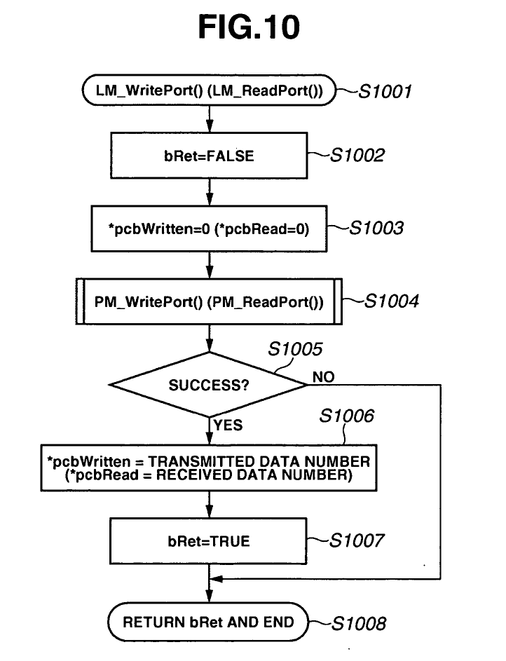

FIG. 10 is a flowchart showing conventional processing of the LM_WritePort( ) function in the LM 36 described with reference to FIGS. 5 and 6 and the LM_ReadPort( ) function in the LM 36 described with reference to FIG. 24. In FIG. 10, regarding the step including a parenthesized portion, the processing relating to the LM_ReadPort( ) function is described in parentheses. The processing relating to the LM_WritePort( ) function is not parenthesized. Furthermore, the step including no parenthesized portion describes the processing common to the LM_WritePort( ) function and the LM_ReadPort( ) function. In the following description, the processing relating only to the LM_ReadPort( ) function is described in parentheses.

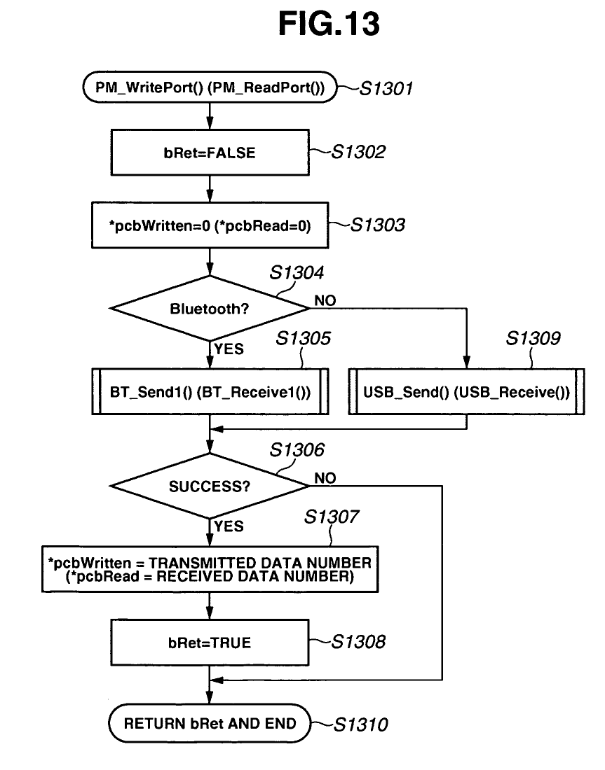

In FIG. 10, when the LM 36 starts the LM_WritePort( ) function (LM_ReadPort( ) function) (refer to step S1001), the LM 36 performs initialization by substituting FALSE representing failure for the bRet, i.e., a returned value of the function (refer to step S1002). And, the LM 36 substitutes 0 for the *pcbWritten of the LM_WritePort( ) function (the *pcbRead of the LM_ReadPort( ) function) shown in FIG. 27 (refer to step S1003). Then, the LM 36 calls the PM_WritePort( ) function (PM_ReadPort( ) function) of the PM 37 described in FIG. 13 (refer to step S1004). When the PM_WritePort( ) function (PM_ReadPort( ) function) ends in success (refer to step S1005), the LM 36 substitutes a transmitted data number for the *pcbWritten (a received data number for the *pcbRead) (refer to step S1006). Then, the LM 36 substitutes TRUE representing success for the bRet (refer to step S1007). Then, the LM 36 returns the bRet to the Spooler and terminates the function (refer to step S1008). In step S1005, if the PM_WritePort( ) function (PM_ReadPort( ) function) ends in failure and the LM 36 receives FALSE representing failure, the LM 36 proceeds to step S1008 to return the bRet and terminate the function.

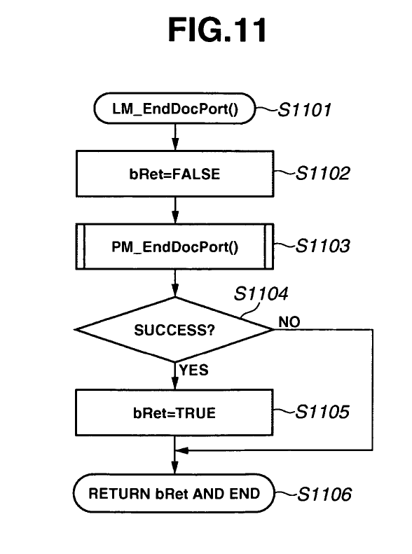

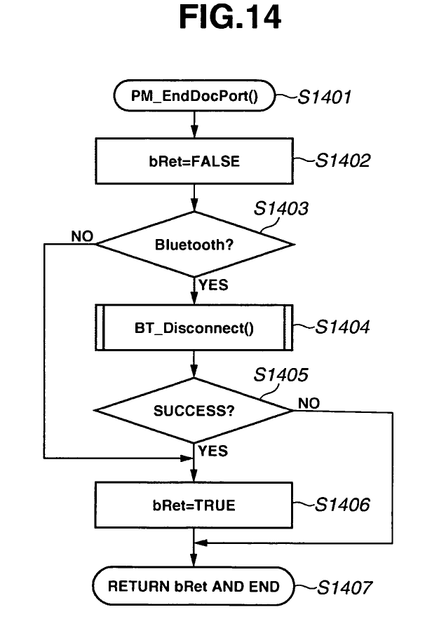

FIG. 11 is a flowchart showing conventional processing of the LM_EndDocPort( ) function in the LM 36 described with reference to FIGS. 5 and 6. When the LM 36 starts the LM_EndDocPort( ) function (refer to step S1101), the LM 36 performs initialization by substituting FALSE representing failure for the bRet, i.e., a returned value of the function (refer to step S1102). Then, the LM 36 calls the PM_EndDocPort( ) function in the PM 37 described with reference to FIG. 14 (refer to step S1103). When the PM_EndDocPort( ) function ends in success and TRUE is returned from the PM 37 (refer to step S1104), the LM 36 substitutes TRUE representing success for the bRet (refer to step S1105). The LM 36 returns the bRet to the Spooler and terminates the function (refer to step S1106). In step S1104, when the PM_EndDocPort( ) function ends in failure and FALSE representing failure is returned, the LM 36 proceeds to step S1106 to return the bRet and terminate the function.

FIG. 12 is a flowchart showing conventional processing of the PM_StartDocPort( ) function in the PM 37 described with reference to FIGS. 5 and 6. When the PM 37 starts the PM_StartDocPort( ) function (refer to step S1201), the PM 37 performs initialization by substituting FALSE representing failure for the bRet, i.e., a returned value of the function (refer to step S1202). In the case of Bluetooth communications (refer to step S1203), the PM 37 calls the BT_Connect( ) function described in FIG. 22 (refer to step S1204). When the BT_Connect( ) function ends in success and TRUE is returned from the Bluetooth HW (Stack) (refer to step S1205), the PM 37 substitutes TRUE representing success for the bRet (refer to step S1206). The PM 37 returns the bRet to the LM 36 and terminates the function (refer to step S1207). In step S1205, if the BT_Connect( ) function ends in failure and FALSE representing failure is returned, the PM 37 proceeds to step S1207 to return the bRet and terminate the function. In the case of USB communications (i.e., NO in step S1203, the PM 37 proceeds to step S1206.

FIG. 13 is a flowchart showing conventional processing of the PM_WritePort( ) function in the PM 37 described with reference to FIGS. 5 and 6 and the PM_ReadPort( ) function in the PM 37 described with reference to FIG. 24. In FIG. 13, regarding the step including a parenthesized portion, the processing relating to the PM_ReadPort( ) function is described in parentheses. The processing relating to the PM_WritePort( ) function is not parenthesized. Furthermore, the step including no parenthesized portion describes the processing common to the PM_WritePort( ) function and the PM_ReadPort( ) function. In the following description, the processing relating only to the PM_ReadPort( ) function is described in parentheses.

In FIG. 13, when the PM 37 starts the PM_WritePort( ) function (PM_ReadPort( ) function) (refer to step S1301), the PM 37 performs initialization by substituting FALSE representing failure for the bRet, i.e., a returned value of the function (refer to step S1302). Furthermore, the PM 37 performs initialization by substituting 0 for the *pcbWritten of the PM_WritePort( ) function (the *pcbRead of the PM_ReadPort( ) function) shown in FIG. 28 (refer to step S1303). In the case of Bluetooth communications (refer to step S1304), the PM 37 calls the BT_Send1( ) function (BT_Receive1( ) function) described in FIG. 15 (refer to step S1305). In the case of USB communications (i.e., NO in step S1304), the PM 37 calls the USB_Send( ) function (USB_Receive( ) function) (refer to step S1309).

In the Bluetooth communications, if the BT_Send1( ) function (BT_Receive1( ) function) ends in success (refer to step S1306), the PM 37 substitutes a transmitted data number for the *pcbWritten (a received data number for the *pcbRead) (refer to step S1307). In the USB communications, if the USB_Send( ) function (USB_Receive( ) function)) ends in success (refer to step S1306), the PM 37 substitutes a transmitted data number for the *pcbWritten (a received data number for the *pcbRead) (refer to step S1307). Then, the PM 37 substitutes TRUE representing success for the bRet (refer to step S1308). The PM 37 returns the bRet to the LM 36 and terminates the function (refer to step S1310). In step S1306, in the case of the Bluetooth communications, if FALSE representing failure of the BT_Send1( ) function (BT_Receive1( ) function) is returned, the PM 37 proceeds to step S1310 to return the bRet and terminate the function. In the case of the USB communications, if FALSE representing failure of the USB_Send( ) function (USB_Receive( ) function)), the PM 37 proceeds to step S1310 to return the bRet and terminate the function.

FIG. 14 is a flowchart showing conventional processing of the PM_EndDocPort( ) function in the PM 37 described with reference to FIGS. 5 and 6. When the PM 37 starts the PM_EndDocPort( ) function (refer to step S1401), the PM 37 performs initialization by substituting FALSE representing failure for the bRet, i.e., a returned value of the function (refer to step S1402). In the case of Bluetooth communications (refer to step S1403), the PM 37 calls the BT_Disconnect( ) function described in FIG. 23 (refer to step S1404). When the BT_Disconnect( ) function ends in success and TRUE is returned from the Bluetooth HW (Stack) (refer to step S1405), the PM 37 substitutes TRUE representing success for the bRet (refer to step S1406). The PM 37 returns the bRet to the LM 36 and terminates the function (refer to step S1407). In step S1405, when the BT_Disconnect( ) function ends in failure and FALSE representing failure is returned, the PM 37 proceeds to step S1407 to return the bRet and terminate the function. In step S1403, in the case of USB communications (i.e., NO in step S1403), the PM 37 proceeds to step S1406.

FIG. 22 is a flowchart showing exemplary processing of the BT_Connect( ) function in the Bluetooth HW (Stack) described with reference to FIGS. 6 and 7. When the Bluetooth HW (Stack) starts the BT_Connect( ) function (refer to step S2201), the Bluetooth HW (Stack) performs initialization by substituting FALSE representing failure for the bRet, i.e., a returned value of the function (refer to step S2202). Then, the Bluetooth HW (Stack) confirms a state of the communication link for the Bluetooth communications (ACL and HCRP) (refer to step S2203). When the communication link is already establish (refer to step S2204), the Bluetooth HW (Stack) substitutes TRUE representing success for the bRet (refer to step S2207) and returns the bRet to the PM 37 before terminating the function (refer to step S2208). In step S2204, if the communication link is not established, the Bluetooth HW (Stack) tries to establish the communication link (refer to step S2205). When the communication link is established (refer to step S2206), the processing flow proceeds to step S2207. In step S2206, if the communication link is not established, the processing flow proceeds to step S2208 to return the bRet and terminate the function.

FIG. 15 is a flowchart showing conventional processing of the USB_Send( ) function (refer to FIG. 5) or the USB_Receive( ) function (refer to FIG. 26) in the USB HW (Stack) and the BT_Send1( ) function (refer to FIG. 6) or the BT_Receive1( ) function (refer to FIG. 24) in the Bluetooth HW (Stack). In FIG. 15, regarding the step including a parenthesized portion, the processing relating to the USB_Receive( ) function or the BT_Receive1( ) function is described in parentheses. The processing relating to the USB_Send( ) function or the BT_Send1( ) function is not parenthesized. Furthermore, the step including no parenthesized portion (except for step S1512) describes the processing common to the USB_Send( ) function or the BT_Send1( ) function and the USB_Receive( ) function or the BT_Receive1( ) function. In the following description, the processing relating only to the USB_Receive( ) function or the BT_Receive1( ) function is described in parentheses.

In FIG. 15, when the USB_Send( ) or the BT_Send1( ) function (the USB_Receive( ) function or the BT_Receive1( ) function) is started (refer to step S1501), the processing flow proceeds to step S1502. In step S1502, initialization is performed by substituting FALSE representing failure for the bRet, i.e., a returned value of the function (refer to step S1502). Further initialization is performed by substituting 0 for the *pcbWritten of the USB_Send( ) function shown in FIG. 30 (for the *pcbRead of the USB_Receive( ) function shown in FIG. 30) (refer to step S1503). And also, further initialization is performed by substituting 0 for the *pcbWritten of the BT_Send1( ) function shown in FIG. 31 (for the *pcbRead of the BT_Receive1( ) function shown in FIG. 31) (refer to step S1503). Then, the USB HW (Stack) or the Bluetooth HW (Stack) confirms an idle state of the USB interface 4 or the Bluetooth interface 9 to which the printer 3 is connected (refer to step S1504).

When the USB interface 4 or the Bluetooth interface 9 is in an idle state (refer to step S1505), the USB HW (Stack) or the Bluetooth HW (Stack) transmits (receives) a data packet (refer to step S1506) and adds a transmitted data number to the *pcbWritten (adds a received data number to the *pcbRead) (refer to step S1507). When the value of *pcbWritten is equal to the value of cbBuf shown in FIG. 30 or 31 (i.e., when the value of *pcbRead is greater than 0 and not greater than the value of cbBuffer) (refer to step S1508), the USB HW (Stack) or the Bluetooth HW (Stack) substitutes TRUE representing success for the bRet (refer to step S1510) and returns the bRet to the PM 37 before terminating the function (refer to step S1513). In step S1508, if the value of *pcbWritten is smaller than the value of cbBuf (the value of *pcbRead is equal to 0), the processing flow proceeds to step S1509 to confirm elapse of the Write (Read) time-out time that is set in step S533 of FIG. 5 or in step S639 of FIG. 6. When the Write (Read) time-out time has elapsed (refer to step S1509), the processing flow proceeds to step S1510. In step S1509, if the Write (Read) time-out time has not elapsed yet, the processing flow returns to step S1504. In step S1505, if the USB interface 4 or the Bluetooth interface 9 is not in an idle state, the USB HW (Stack) or the Bluetooth HW (Stack) confirms whether NAK is returned from the USB port 6 or the Bluetooth port 8 of the printer 3 (refer to step S1511).

When a reception buffer of the printer 3 is full, the printer 3 cannot receive data from the PC 1. For example, the reception buffer of the printer 3 becomes full, when the data transfer rate from the PC 1 to the printer 3 is so high that the printer 3 cannot control the print and as a result the reception buffer of the printer 3 becomes full. Furthermore, the reception buffer of the printer 3 becomes full when the printer 3 has no residual recording papers. In this case, the printer 3 transmits NAK to the PC 1. The PC 1 can receive the NAK in a normal communication state where the communication link for the Bluetooth communications or the USB communications is established between the PC1 and the printer 3. However, if no communication link is established, the PC1 cannot communicate with the printer 3 and accordingly cannot receive the NAK. Accordingly, in step S1511, the USB HW (Stack) or the Bluetooth HW (Stack) can detect any abnormality in the communication path by confirming the presence of NAK returned from the USB port 6 or the Bluetooth port 8 of the printer 3.

In step S1511, if the NAK is returned from the USB port 6 or the Bluetooth port 8 of the printer 3, the PC1 can communicate with the printer 3. The processing flow proceeds to step S1508. In step S1511, if the NAK is not returned, there is an abnormality in the USB communications or the Bluetooth communications. Then, in the case of the USB_Send( ) function or the BT_Send1( ) function, the USB HW (Stack) or the Bluetooth HW (Stack) clears the buffer of untransmitted data to prevent and/or reduced error transmission in the succeeding processing (refer to step S1512). Then, the processing flow proceeds to step S1513 to return the bRet to the PM 37 and terminate the function. As apparent from the foregoing description, a first communication state confirmation unit is provided to confirm an idle state of the USB interface 4 or the Bluetooth interface 9 in step S1504. The first communication state confirmation unit is used for confirming whether the printer 3 is in an enabling state for data reception (transmission) under a condition that the communication link is established

FIG. 23 is a flowchart showing exemplary processing of the BT_Disconnect( ) function in the Bluetooth HW (Stack) described with reference to FIGS. 6 and 8. When the Bluetooth HW (Stack) starts the BT_Disconnect( ) function (refer to step S2301), the Bluetooth HW (Stack) performs initialization by substituting FALSE representing failure for the bRet, i.e., a returned value of the function (refer to step S2302). Then, the Bluetooth HW (Stack) confirms a state of the communication link for the Bluetooth communications (ACL and HCRP) (refer to step S2303). When the communication link is established (refer to step S2304), the Bluetooth HW (Stack) tries to disconnect the communication link (refer to step S2305). When the communication link is disconnected (refer to step S2306), the Bluetooth HW (Stack) substitutes TRUE representing success for the bRet (refer to step S2307) and return the bRet to the PM 37 and terminate the function (refer to step S2308). In step S2306, if the communication link is not disconnected, the processing flow proceeds to step S2308 to return the bRet and terminate the function. In step S2304, if the communication link is not established, the processing flow proceeds to step S2307.

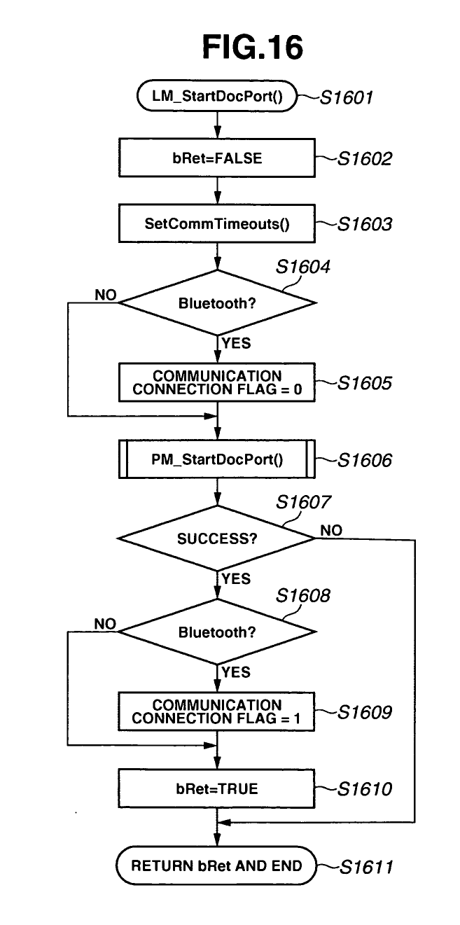

FIG. 16 is a flowchart showing exemplary processing of the LM_StartDocPort( ) function in the LM 36 described with reference to FIG. 7, provided in the present exemplary embodiment. The processing shown in FIG. 16 can be also applied to the LM_StartDocPort( ) function in the LM 36 described with reference to FIGS. 5 and 26.

In FIG. 16, when the LM 36 starts the LM_StartDocPort( ) function (refer to step S1601), the LM 36 performs initialization by substituting FALSE representing failure for the bRet, i.e., a returned value of the function (refer to step S1602). Furthermore, the LM 36 calls the SetCommTimeouts( ) function and sets the Write/Read time-out times for the USB communications or Bluetooth communications (refer to step S1603). Then, the LM 36 determines whether the communication link is established for the Bluetooth communications (or for the USB communications). When the communication link is established for the Bluetooth communications (refer to step S1604), the LM 36 performs initialization by clearing a communication connection flag representing a connection state of the Bluetooth communications, i.e., BT_Connection_Flag=0 (refer to step S1605). Then, the LM 36 calls the PM_StartDocPort( ) function of the PM 37 described in FIG. 12 (refer to step S1606).

When the PM_StartDocPort( ) function ends in success and TRUE is returned (refer to step S1607), the LM 36 determines whether the communication link is established for the Bluetooth communications (refer to step S1608). When the communication link is established for the Bluetooth communications, the LM 36 sets the communication connection flag, i.e., BT_Connection_Flag=1 (refer to step S1609). The processing flow proceeds to step S1610. In step S1610, the LM 36 substitutes TRUE representing success for the bRet (refer to step S1610) and returns the bRet to the Spooler before terminating the function (refer to step S1611). In step S1604, if the communication link is not established for the Bluetooth communications (i.e., not for the USB communications), the processing flow proceeds to step S1606. In step S1607, if the PM_StartDocPort( ) function ends in failure and FALSE representing failure is returned, the processing flow proceeds to step S1611 to return the bRet and terminate the function. In step S1608, if the communication link is established for the Bluetooth communications (i.e., for the USB communications), the processing flow proceeds to step S1610.

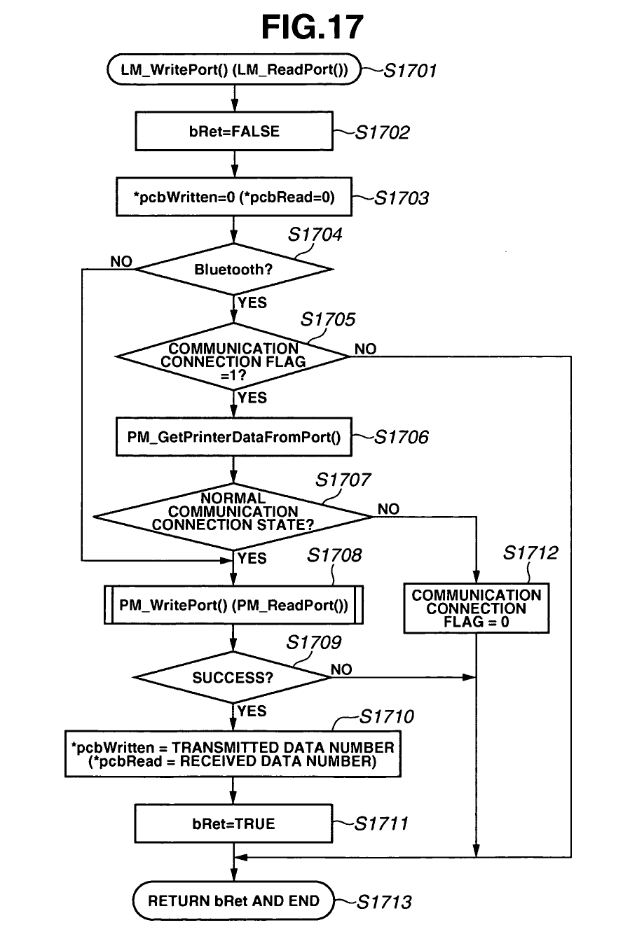

FIG. 17 is a flowchart showing exemplary processing of the LM_WritePort( ) function in the LM 36 described with reference to FIG. 7 and the LM_ReadPort( ) function in the LM 36 described in FIG. 25, provided in the present exemplary embodiment. The processing shown in FIG. 17 can be also applied to the LM_WritePort( ) function in the LM 36 described with reference to FIGS. 5 and 26. In FIG. 17, regarding step including a parenthesized portion, the processing relating to the LM_ReadPort( ) function is described in parentheses. The processing relating to the LM_WritePort( ) function is not parenthesized. Furthermore, step including no parenthesized portion describes the processing common to the LM_WritePort( ) function and the LM_ReadPort( ) function. In the following description, the processing relating only to the LM_ReadPort( ) function is described in parentheses.

In FIG. 17, when the LM 36 starts the LM_WritePort( ) function (LM_ReadPort( ) function) (refer to step S1701), the LM 36 performs initialization by substituting FALSE representing failure for the bRet, i.e., a returned value of the function (refer to step S1702). Furthermore, the LM 36 performs initialization by substituting 0 for the *pcbWritten of the LM_WritePort( ) function (for the *pcbRead of the LM_ReadPort( ) function) shown in FIG. 27 (refer to step S1703). Then, the LM 36 determines whether the communication link is established for the Bluetooth communications (or for the USB communications). When the communication link is established for Bluetooth communications (refer to step S1704), the processing flow proceeds to step S1705. When the communication connection flag representing a connection state of the Bluetooth communications is set, i.e., BT_Connection_Flag=1 (refer to step S1705), the processing flow proceeds to step S1706. The LM 36 sets IOCTL_BLUETOOTH_COMMUNICATION in the Control ID (refer to FIG. 29) and calls the PM_GetPrinterDataFromPort( ) function in the PM 37 (refer to step S1706).

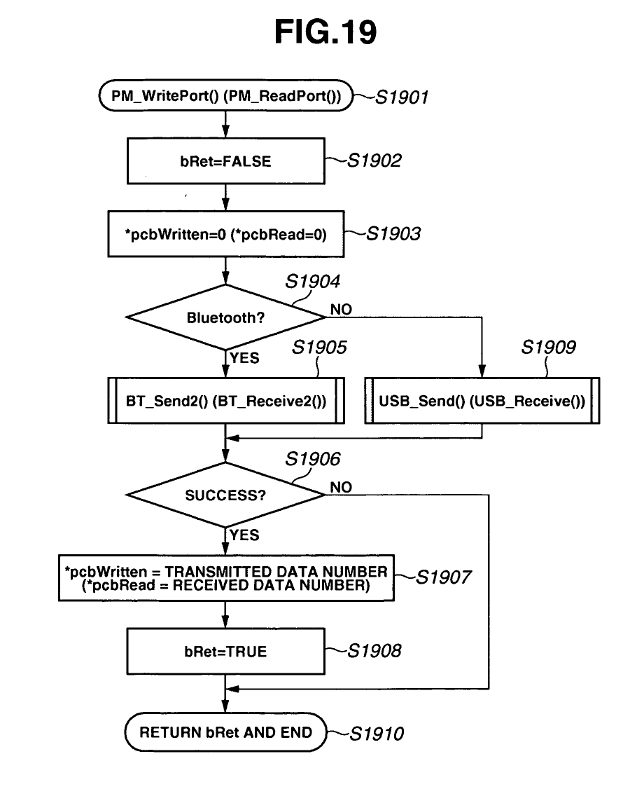

When the PM_GetPrinterDataFromPort( ) function is returned from the PM 37 and the value of the *lpOutBuffer (refer to FIG. 29) is equal to BLUETOOTH_CONNECTED (refer to step S1707), the LM 36 calls the PM_WritePort( ) function (PM_ReadPort( ) function) (refer to step S1708). Namely, when the value of the *lpOutBuffer represents a normal state of the communication link for the Bluetooth communications (refer to step S1707), the LM 36 calls the PM_WritePort( ) function (PM_ReadPort( ) function) (refer to step S1708). Details will be described later with reference to FIG. 19.

When TRUE representing success of the PM_WritePort( ) function (PM_ReadPort( ) function) is returned from the PM 37 (refer to step S1709), the LM 36 substitutes a transmitted data number for the *pcbWritten (a received data number for the *pcbRead) (refer to step S1710). Then, the LM 36 substitutes TRUE representing success for the bRet (refer to step S1711) and returns the bRet to the Spooler before terminating the function (refer to step S1713). In step S1709, if the PM_WritePort( ) function (PM_ReadPort( ) function) ends in failure and FALSE representing failure is returned, the processing flow proceeds to step S1713 to return the bRet and terminate the function.

In step S1707, if the value of the *lpOutBuffer is different from BLUETOOTH_CONNECTED, the communication state is abnormal and therefore the LM 36 clears the communication connection flag, BT_Connection_Flag=0 (refer to step S1712). Then, the processing flow proceeds to step S1713 to return the bRet and terminate the function. In step S1705, if the communication connection flag is cleared, i.e., BT_Connection_Flag=0, the processing flow proceeds to step S1713 to return the bRet and terminate the function. In step S1704, if the communication link is not established for the Bluetooth communications (i.e., for the USB communications), the processing flow proceeds to step S1708.

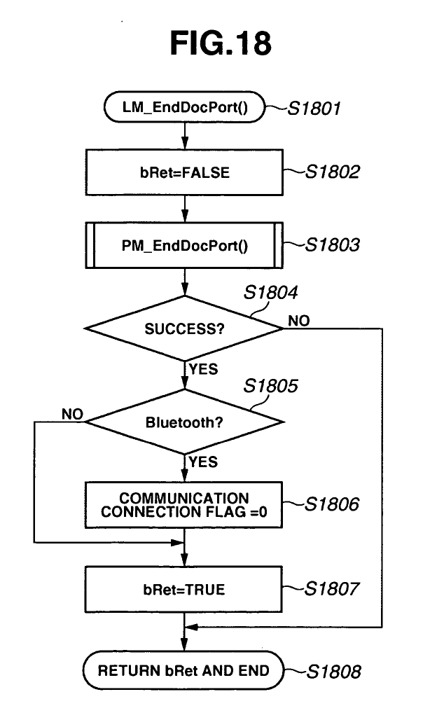

FIG. 18 is a flowchart showing exemplary processing of the LM_EndDocPort( ) function in the LM 36 described with reference to FIG. 8, provided in the present exemplary embodiment. The processing shown in FIG. 18 can be also applied to the LM_EndDocPort( ) function in the LM 36 described with reference to FIGS. 5 and 26.

In FIG. 18, when the LM 36 starts the LM_EndDocPort( ) function (refer to step S1801), the LM 36 performs initialization by substituting FALSE representing failure for the bRet, i.e., a returned value of the function (refer to step S1802). Then, the LM 36 calls the PM_EndDocPort( ) function of the PM 37 described with reference to FIG. 14 (refer to step S1803). When the PM_EndDocPort( ) function ends in success and TRUE is returned from the PM 37 (refer to step S1804), the LM 36 determines whether the communication link is established for the Bluetooth communications (or for the USB communications) (refer to step S1805).

When the communication link is established for the Bluetooth communications (refer to step S1805), the LM 36 performs initialization by clearing a communication connection flag representing a connection state of the Bluetooth communications, i.e., BT_Connection_Flag=0 (refer to step S1806). Then, the LM 36 substitutes TRUE representing success for the bRet (refer to step S1807) and returns the bRet to the Spooler before terminating the function (refer to step S1808). In step S1805, if the communication link is not established for the Bluetooth communications (i.e., for the USB communications), the processing flow proceeds to step S1807. In step S1804, if the PM_EndDocPort( ) function ends in failure and FALSE representing failure is returned, the processing flow proceeds to step S1808 to return the bRet and terminate the function.

FIG. 19 is a flowchart showing exemplary processing of the PM_WritePort( ) function in the PM 37 described with reference to FIG. 7 and the PM_ReadPort( ) function in the PM 37 described with reference to FIG. 25, provided in the present exemplary embodiment. The processing shown in FIG. 19 can be also applied to the PM_WritePort( ) function in the LM 36 described with reference to FIGS. 5 and 26. In FIG. 19, regarding the step including a parenthesized portion, the processing relating to the PM_ReadPort( ) function is described in parentheses. The processing relating to the PM_WritePort( ) function is not parenthesized. Furthermore, the step including no parenthesized portion describes the processing common to the PM_WritePort( ) function and the PM_ReadPort( ) function. In the following description, the processing relating only to the PM_ReadPort( ) function is described in parentheses.

In FIG. 19, when the PM 37 starts the PM_WritePort( ) function (PM_ReadPort( ) function) (refer to step S1901), the PM 37 performs initialization by substituting FALSE representing failure for the bRet, i.e., a returned value of the function (refer to step S1902). Furthermore, the PM 37 performs initialization by substituting 0 for the *pcbWritten of the PM_WritePort( ) function shown in FIG. 28 (for the *pcbRead of the PM_ReadPort( ) function) (refer to step S1903). Next, the PM 37 determines whether the communication link is established for the Bluetooth communications (or for the USB communications). When the communication link is established for the Bluetooth communications (refer to step S1904), the PM 37 calls the BT_Send2( ) function (BT_Receive2( ) function) described in FIG. 21 (refer to step S1905). In step S1904, if the communication link is not established for the Bluetooth communications (established for the USB communications), the PM 37 calls the USB_Send( ) function (USB_Receive( ) function) described in FIG. 15 (refer to step S1909).

In the case of the Bluetooth communications, the PM 37 determines whether TRUE representing success of the BT_Send2( ) function (BT_Receive2( ) function) is returned from the Bluetooth HW (Stack) (refer to step S1906). When TRUE is returned, the PM 37 substitutes a transmitted data number for the *pcbWritten (a received data number for the *pcbRead) (refer to step S1907). In the case of the USB communications, the PM 37 determines whether TRUE representing success of the USB_Send( ) function (USB_Receive( ) function) is returned from the USB HW (Stack) (refer to step S1906). When TRUE is returned, the PM 37 substitutes a transmitted data number for the *pcbWritten (a received data number for the *pcbRead) (refer to step S1907). Then, the PM 37 substitutes TRUE representing success for the bRet (refer to step S1908) and returns the bRet to the LM 36 before terminating the function (refer to step S1910). In step S1906, if the BT_Send2( ) function (BT_Receive2( ) function) ends in failure and FALSE representing failure is returned, the processing flow proceeds to step S1910 to return the bRet and terminate the function.

FIG. 20 is a flowchart showing exemplary processing of the BT_CheckConnection( ) function in the Bluetooth HW (Stack) described with reference to FIGS. 7 and 25, provided in the present exemplary embodiment. First, when the Bluetooth HW (Stack) starts the BT_CheckConnection( ) function (refer to step S2001), the Bluetooth HW (Stack) performs initialization by substituting BLUETOOTH_DISCONNECTED for the dwRet, i.e., a returned value (refer to step S2002). Namely, initialization is performed by substituting a value representing a disconnected state of the Bluetooth communication link for the dwRet (refer to step S2002). Then, the Bluetooth HW (Stack) confirms a state of the communication link for the Bluetooth communications (ACL and HCRP) (refer to step S2003). When the communication link is established (i.e., in a normal state) (refer to step S2004), the Bluetooth HW (Stack) substitutes BLUETOOTH_CONNECTED for the dwRet, wherein BLUETOOTH_CONNECTED represents a normal state where the communication link for the Bluetooth communications is established (refer to step S2012). Then, the Bluetooth HW (Stack) returns the dwRet to the PM 37 and terminates the function (refer to step S2014).

In step S2004, if the communication link is not normally established, the Bluetooth HW (Stack) confirms whether a communication disconnection request packet is transmitted from the Bluetooth port 8 of the printer 3, wherein the communication disconnection request packet represents a request for disconnecting the communications (refer to step S2005). When the communication disconnection request packet is transmitted (refer to step S2006), the Bluetooth HW (Stack) calls the BT_Disconnect( ) function shown in FIG. 23 and disconnects the communication link (refer to step S2013). Then, the processing flow proceeds to step S2014 to return the dwRet and terminate the function. For example, if a user forcibly turns off the power source of the printer 3 during a printing operation, a communication disconnection request packet is transmitted from the Bluetooth port 8 of the printer 3.

In step S2006, if no communication disconnection request packet is transmitted, the Bluetooth HW (Stack) executes recovery processing for the Bluetooth communications (refer to step S2007). For example, a printing operation may be performed when the Bluetooth wireless communications are performed in deteriorated radio wave conditions. In such a condition, it is unknown whether the communication link for the Bluetooth communications is established or disconnected. Thus, the recovery processing is required. When the recovery processing for the Bluetooth communications ends in success (refer to step S2008), the Bluetooth HW (Stack) substitutes BLUETOOTH_RECOVERED for the dwRet, wherein BLUETOOTH_RECOVERED represents a recovery of the Bluetooth communications to a normal state where the communication link is established (refer to step S2009). Then, the Bluetooth HW (Stack) returns the dwRet to the PM 37 and terminates the function in step S2014.

If the recovery processing for the Bluetooth communications is failed (refer to step S2008), the Bluetooth HW (Stack) determines whether a maximum time has elapsed since interrupt of a response returning from the device (i.e., the Bluetooth port 8 of the printer 3), where the maximum time is determined in the spec of the Bluetooth communications as a period of time during which the communication link can be maintained. When the maximum time has not elapsed yet, the recovery processing is currently progressing (refer to step S2010) and accordingly the Bluetooth HW (Stack) substitutes BLUETOOTH_UNKNOWN for the dwRet, wherein BLUETOOTH_UNKNOWN represents a state where establishment or disconnection of the communication link for the Bluetooth communications is unclear (refer to step S2011). Then, the Bluetooth HW (Stack) returns the dwRet to the PM 37 and terminates the function. In step S2010, if the maximum time has elapsed and the recovery becomes impossible, the processing flow proceeds to step S2013.

As described above, the processing for the BT_CheckConnection( ) function shown in FIG. 20 is executed by the communication state confirmation unit (second communication state confirmation unit) in the LM 36 shown in FIGS. 7 and 25 provided for confirming a communication state of the communication link for the Bluetooth communications. The printer driver 50 can use the provided communication state confirmation unit to realize a safe transmission of data from the PC 1 to the printer 3. The logic of the communication state confirmation unit of the BT_CheckConnection( ) function for confirming the communication state of the communication link for the Bluetooth communications is different from the logic of the communication state confirmation unit of the Bluetooth HW (Stack) shown in FIGS. 15 and 21 for confirming the communication state of the communication link. If the communication link once shifts to the state of BLUETOOTH_RECOVERED or BLUETOOTH_UNKNOWN, there is a possibility that the communication link for the Bluetooth communications has been once disconnected.

More specifically, when the Bluetooth communications are recovered to a normal state where the communication link is establish, or when establishment or disconnection of the communication link for the Bluetooth communications is unknown, there is a possibility that the communication link has been once disconnected. Therefore, to prevent and/or reduce incorrect print or other malfunction of the printer 3, only the case of BLUETOOTH_CONNECTED representing a normal state of the communication link for the Bluetooth communications (i.e., step S728 of FIG. 7 or step S2511 of FIG. 25) is processed as normal. Other cases of BLUETOOTH_RECOVERED, BLUETOOTH_UNKNOWN, and BLUETOOTH_DISCONNECTED are processed as errors.

FIG. 21 is a flowchart showing exemplary processing of the BT_Send2( ) function in the Bluetooth HW (Stack) of FIG. 7 and the BT_Receive2( ) function in the Bluetooth HW (Stack) of FIG. 25, provided in the present exemplary embodiment. In FIG. 21, regarding the step including a parenthesized portion, the processing relating to the BT_Receive2( ) function is described in parentheses. The processing relating to the BT_Send2( ) function is not parenthesized. Furthermore, the step including no parenthesized portion (except for step S2116) describes the processing common to the BT_Send2( ) function and the BT_Receive2( ) function. In the following description, the processing relating only to the BT_Receive2( ) function is described in parentheses.

In FIG. 21, when the Bluetooth HW (Stack) starts the BT_Send2( ) function (BT_Receive2( ) function) (refer to step S2101), the Bluetooth HW (Stack) performs initialization by substituting FALSE representing failure for the bRet, i.e., a returned value of the function (refer to step S2102). Furthermore, the Bluetooth HW (Stack) performs initialization by substituting 0 for the *pcbWritten of the BT_Send2( ) function (for the *pcbRead of the BT_Receive2( ) function) shown in FIG. 31 (refer to step S2103). Then, the Bluetooth HW (Stack) calls the BT_CheckConnection( ) function shown in FIG. 20 and confirms a state of the communication link for the Bluetooth communications (ACL and HCRP) (refer to step S2104). When the communication link is already establish (refer to step S2105), the Bluetooth HW (Stack) confirms an idle state of the USB interface 4 or the Bluetooth interface 9 to which the printer 3 is connected (refer to step S2108).

When the USB interface 4 or the Bluetooth interface 9 is in an idle state (refer to step 2109), the Bluetooth HW (Stack) transmits (receives) a data packet (refer to step S2110) and adds a transmitted data number to the *pcbWritten (a received data number to the *pcbRead) (refer to step S2111). Then, the Bluetooth HW (Stack) determines whether the value of *pcbWritten is equal to the value of cbBuf shown in FIG. 31 (whether the value of *pcbRead is greater than 0 and not greater than the value of cbBuffer) (refer to step S2112). When the value of *pcbWritten is equal to the value of cbBuf shown in FIG. 31 (refer to step S2112), the Bluetooth HW (Stack) substitutes TRUE representing success for the bRet (refer to step S2114) and returns the bRet to the PM 37 before terminating the function (refer to step S2117). In step S2112, if the value of *pcbWritten is smaller than the value of cbBuf (when the value of *pcbRead is 0), the Bluetooth HW (Stack) determines whether the Write (Read) time-out time set in step S639 of FIG. 6 has elapsed (refer to step S2113). When the Write (Read) time-out time has elapsed (refer to step S2113), the processing flow proceeds to step S2114. In step S2113, if the Write (Read) time-out time has not elapsed yet, the processing flow returns to step S2108. In step S2109, if the USB interface 4 or the Bluetooth interface 9 is not in an idle state, the Bluetooth HW (Stack) confirms the presence of NAK returned from the Bluetooth port 8 of the printer 3 (refer to step S2115).

As described in FIG. 15, the Bluetooth HW (Stack) determines abnormality of the communication path by confirming whether the NAK is returned from the USB port 6 or the Bluetooth port 8 of the printer 3. When the NAK is returned (refer to step S2115), the Bluetooth communications are normally performed and accordingly the processing flow proceeds to step S2112. In step S2115, if the NAK is not returned, there is an abnormality in the Bluetooth communications. In the case of the BT_Send2( ) function, the Bluetooth HW (Stack) clears the buffer of untransmitted data to prevent and/or reduce error transmission in the succeeding processing (refer to step S2116). Then, the processing flow proceeds to step S2117 to return the bRet to the PM 37 and terminate the function. In step S2105, if the communication link is not established, the Bluetooth HW (Stack) calls the BT_Connect( ) function shown in FIG. 22 and tries to establish the communication link for the Bluetooth communications (ACL and HCRP) (refer to step S2106). When the communication link is established (refer to step S2107), the processing flow proceeds to step S2108. In step S2107, if the communication link is not established, the processing flow proceeds to step S2116.

As described above, in the processing provided in the present exemplary embodiment, the first communication state confirmation unit similar to that described in FIG. 15 is provided to confirm an idle state of the Bluetooth interface 9 (refer to step S2108). The first communication state confirmation unit is utilized for confirming whether the printer 3 is in an enabling state for data reception (transmission) under a condition that the communication link is established.

Furthermore, in step S2104, the Bluetooth HW (Stack) confirms a state of the communication link for the Bluetooth communications. If the communication link is not established, the Bluetooth HW (Stack) establishes (again) the communication link for the recovery in step S2106. With this processing, the print job does not end in failure due to deteriorated or disconnected communications. The print job can be continued and accomplished even when the communications are deteriorated or disconnected during a printing operation. The processing of calling the LM_StartDocPort( ) function in the LM 36 in response to a start of a printing operation (refer to step S605) and establishing the communication link for the Bluetooth communications (refer to step S611) in the conventional function flow of FIG. 6 is executed (refer to step S2106) when the LM_WritePort( ) function in the LM 36 is called (refer to step S718 in FIG. 7) as well as when the LM_ReadPort( ) function in the LM 36 is called (refer to step S2501 in FIG. 25).

Accordingly, for example, when the communication link is disconnected during a printing operation due to deteriorated radio wave conditions for the Bluetooth communications, the print job does not end in failure and the printing operation can be surely accomplished. The logic of the recovery processing in this case is different from the logic of the recovery processing executed in step S2007 of FIG. 20. In this manner, executing two (plural) recovery processing (i.e., executing two (plural) processing for reestablishing the communication link for the Bluetooth communications) mutually different in their logics is new characteristic technique.

Although not shown in the drawings, the storage medium can store any information (e.g., version information, creators, etc.) required for managing the program groups stored in this storage medium and another information depending on the OS that reads the programs, such as icons required for realizing a discriminative display for the programs.

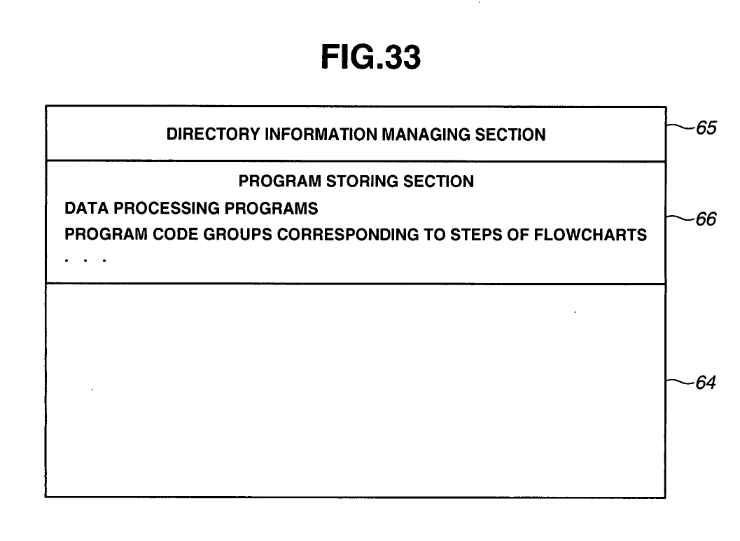

FIG. 33 is a memory map of a storage medium that stores various data processing programs readable by the peripheral apparatus control system including the information processing apparatus and the peripheral apparatus according to the above-described exemplary embodiment.

A storage medium 64 can be constructed from a hard disk. A directory information managing section 65 can manage data belonging to various programs. A program storing section 66 can store programs required for installing various programs on the information processing apparatus and another programs required for extract compressed programs. The program storing section 66 stores the programs executing the processing corresponding to the function flows shown in FIGS. 5 through 8 and FIGS. 24 through 26 as well as the flowcharts shown in FIGS. 9 through 23 according to exemplary embodiments. The programs can be installed on the information processing apparatus from the outside, so that the information processing apparatus can execute the installed programs to realize the processing corresponding to the above-described function flows and flowcharts. In this case, a storage medium, such as a CD-ROM, a flash memory or a flexible disk, can be used to supply directly, or via a network, information groups including programs to the information processing apparatus or to the peripheral apparatus.

In the above-described exemplary embodiment, the application 30 is a memo pad/Notepad (Notepad.exe) or similar application that can execute a printing operation or a status monitor. However, the above-described exemplary embodiment can be applied to any other application including a printing function or any other application that can use the information obtained from a peripheral apparatus.

Furthermore, in the above-described exemplary embodiment, the application (status monitor) 30 monitors the information and state of inks used in the printer 3. However, the application (status monitor) 30 can be also used to obtain an operation state of a peripheral apparatus, a state of warning or error, and a state of an optional device.

Furthermore, in the above-described exemplary embodiment, the printer is not limited to a color inkjet printer. For example, the color inkjet printer can be replaced with a monochrome LBP or any other printer.

Furthermore, in the above-described exemplary embodiment, the information processing apparatus is not limited to a personal computer. For example, the personal computer can be replaced with a digital camera, a digital video camera, a DVD video player, a game player, a set top box, an Internet appliance, or any other terminal that can use a similar method. Furthermore, in the above-described exemplary embodiment, the peripheral apparatus is not limited to a printer. For example, the printer can be replaced with a copying machine, a facsimile, a scanner, a digital camera, a digital video camera, or a multifunction apparatus including these functions. Furthermore, in the above-described exemplary embodiment, the OS is not limited to Windows (registered trademark) XP. Any other OS can be used.

Furthermore, in the above-described exemplary embodiment, the interface between the PC 1 and the printer 3 is not limited to a Bluetooth interface. For example, the Bluetooth interface can be replaced with a wireless LAN (e.g., IEEE 802.11a/b/g) or any other wireless interface such as a Wireless USB that the Wireless USB Promoter Group has worked out. As apparent from the above description, in a wireless printing system, the communication link for a printing operation may be disconnected due to deteriorated radio wave conditions. However, the printer does not cause incorrect print or any other malfunction in a succeeding print job in response to a print control command.

Furthermore, in the function (of the status monitor) for monitoring a state of a peripheral apparatus, for example, when establishment or disconnection of the communication link is unclear due to deteriorated radio wave conditions for the wireless communications, the status monitor does not fall into an uncontrollable state. Furthermore, a stable state can be continuously maintained. Operability can be improved. A peripheral apparatus does not cause malfunction due to a change in the communication state of the communication interface. Furthermore, an uncontrollable state does not occur due to a change in the communication state of the communication interface.

Furthermore, software program code realizing the above-described functions of the exemplary embodiments can be supplied via a storage medium to a system or an apparatus. A computer (CPU or MPU) of the system or the apparatus can read and execute the supplied program code to realize the functions of the present exemplary embodiments. In this case, the program code read out of the storage medium can realize the functions of the above-described exemplary embodiments. The program code and the storage medium storing the program code can constitute the present invention. The storage medium supplying the program code can be selected from any one of a flexible disk, a hard disk, an optical disk, a magneto-optical disk, a CD-ROM, a CD-R, a CD-RW, a magnetic tape, a nonvolatile memory card, a ROM, and a DVD (DVD-ROM, DVD-R).

Furthermore, realizing the functions of the above-described exemplary embodiments is not limited to executing the program code read by the computer. The operating system (OS) running on the computer can execute part or all of the actual processing based on an instruction of the program code, to realize the functions of the above-described exemplary embodiments.

Furthermore, the program code read out of a storage medium can be written into a memory of a function expansion board equipped in a computer or into a memory of a function expansion unit connected to the computer. In this case, based on an instruction of the program code, a CPU provided on the function expansion board or the function expansion unit can execute part or all of the processing so that the functions of the above-described exemplary embodiments can be realized.

Some functions (information) in the following description may not be described in detail. However, as of May 8, 2005, the Internet site of Microsoft Developer Network (MSDN), i.e., http://msdn.microsoft.com/library/default.asp, can be referred to for more information.

In the previous description; USB stands for Universal Serial Bus that is a wired interface enabling bidirectional communications. Furthermore, Bluetooth is a wireless interface enabling bidirectional communications, whose detailed spec is, for example, disclosed in the Internet site https://www.bluetooth.org/. The following description may include undisclosed functions, as exemplary functions executing the processing that can be estimated from calling sequences.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-155536 filed May 27, 2005, which is hereby incorporated by reference herein in its entirety.

What is claimed is:

1. A peripheral apparatus control system comprising:
an information processing apparatus including,
a communication interface control unit which includes a first confirmation unit; and
a peripheral apparatus control unit which includes a second confirmation unit;
a peripheral apparatus; and
a communication interface configured to provide a communication link between the information processing apparatus and the peripheral apparatus,
wherein the first and second confirmation units are configured to confirm a communication state of the communication interface,
wherein the communication interface control unit is configured to control the communication interface,
wherein the peripheral apparatus control unit is configured to control the peripheral apparatus, and
wherein the peripheral apparatus control unit is configured to communicate with the peripheral apparatus based on a confirmation result of the communication state of the communication interface confirmed by the second confirmation unit.

2. The peripheral apparatus control system according to claim 1, wherein the communication interface is a wireless communication interface.

3. An information processing apparatus configured to communicate with a peripheral apparatus via a communication interface, the information processing apparatus comprising:
a communication interface control unit which includes a first confirmation unit, the communication interface control configured to control the communication interface; and
a peripheral apparatus control unit which includes a second confirmation unit, the peripheral apparatus control unit configured to control the peripheral apparatus,
wherein the first and second confirmation units are configured to confirm a communication state of the communication interface,
wherein the peripheral apparatus control unit is configured to communicate with the peripheral apparatus based on a confirmation result of the communication state of the communication interface confirmed by the second confirmation unit.

4. The information processing apparatus according to claim 3, wherein the communication interface is a wireless communication interface.

5. The information processing apparatus according to claim 3, wherein processing by the first confirmation unit for confirming the communication state of the communication interface differs from processing by the second confirmation unit for confirming the communication state of the communication interface.

6. The information processing apparatus according to claim 3, wherein the communication interface control unit includes an establishment unit configured to establish a communication link via the communication interface.

7. The information processing apparatus according to claim 6, wherein, when the communication link is disconnected, the communication interface control unit is configured to communicate with the peripheral apparatus after the communication link is established.

8. The information processing apparatus according to claim 6, wherein, when disconnection of a communication link is detected by the first confirmation unit, the communication interface control unit discards untransmitted data stored in a buffer configured to store data to be transmitted to the peripheral apparatus.

9. The information processing apparatus according to claim 3, wherein the second confirmation unit confirms whether a communication state of the communication interface is one of a normal, disconnected, reconnected, and unknown state.

10. The information processing apparatus according to claim 9, wherein, when the second confirmation unit has detected that the communication state of the communication interface is a normal state, the information processing apparatus proceeds communication with the peripheral apparatus.

11. The information processing apparatus according to claim 3, wherein the peripheral apparatus control unit includes a determination unit configured to determine whether the communication interface is a first communication interface or a second communication interface.

12. The information processing apparatus according to claim 11, wherein the peripheral apparatus control unit manages a state of the communication interface based on a determination result obtained by the determination unit.

13. The information processing apparatus according to claim 11, wherein the second confirmation unit confirms the communication state of the communication interface based on a determination result obtained by the determination unit.

14. A control method for an information processing apparatus configured to communicate with a peripheral apparatus via a communication interface, the method comprising:
a communication interface control step of controlling the communication interface; and
a peripheral apparatus control step of controlling the peripheral apparatus,
wherein the communication interface control step includes execution of a first confirmation step of confirming a communication state of the communication interface,
wherein the peripheral apparatus control step includes execution of a second confirmation step of confirming a communication state of the communication interface, and
wherein the peripheral apparatus control step further includes communicating with the peripheral apparatus based on a confirmation result of the communication state of the communication interface confirmed in the second confirmation step.

15. A program executable by an information processing apparatus configured to communicate with a peripheral apparatus via a communication interface, the program comprising:
a communication interface control module for controlling the communication interface; and
a peripheral apparatus control module for controlling the peripheral apparatus,
wherein the communication interface control module executes a first confirmation step of confirming a communication state of the communication interface,
wherein the peripheral apparatus control module executes a second confirmation step of confirming a communication state of the communication interface, and
wherein the peripheral apparatus control module further executes processing for communicating with the peripheral apparatus based on a confirmation result of the communication state of the communication interface confirmed in the second confirmation step.

16. The program according to claim 15, wherein the communication interface includes a wireless communication interface.

17. The program according to claim 15, wherein processing in the first confirmation step of confirming the communication state of the communication interface differs from processing in the second confirmation step of confirming the communication state of the communication interface.

18. The program according to claim 15, wherein the communication interface control module executes an establishment step of establishing a communication link of the communication interface.

19. The program according to claim 18, wherein, when the communication link is disconnected, the communication interface control module executes processing for communicating with the peripheral apparatus after the communication link is established in the establishment step.

20. The program according to claim 15, wherein, when disconnection of a communication link of the communication interface is detected in the first confirmation step, the communication interface control module executes processing for discarding untransmitted data stored in a buffer configured to store data to be transmitted to the peripheral apparatus.

21. The program according to claim 15, wherein the second confirmation step includes confirming whether the communication state of the communication interface is one of a normal, disconnected, reconnected, and unknown state.

22. The program according to claim 21, further comprising a communication step of communicating with the peripheral apparatus when the communication state of the communication interface has been detected in the second confirmation step to be a normal state.

23. The program according to claim 15, wherein the peripheral apparatus control module includes a determination step of determining whether the communication interface is a first communication interface or a second communication interface.

24. The program according to claim 23, wherein the peripheral apparatus control module manages a state of the communication interface based on a determination result obtained in the determination step.

25. The program according to claim 23, wherein the second confirmation step includes confirming the communication state of the communication interface based on a determination result obtained in the determination step.
